(19) United States
(12) Patent Application Publication
(10) Pub. No.: US 2009/0128916 A1
(43) Pub. Date: May 21, 2009

(54) CURABLE COMPOSITION AND CURED PRODUCT, LAMINATE FILM AND ANTIREFLECTIVE FILM USING THE SAME AND POLARIZING PLATE AND IMAGE DISPLAY DEVICE USING THE ANTIREFLECTIVE FILM

(76) Inventor: Masaki Noro, Kanagawa (JP)

Correspondence Address: BIRCH STEWART KOLASCH & BIRCH, PO BOX 747, FALLS CHURCH, VA, 22040-0747, US

(21) Appl. No.: 12/092,050

(22) PCT Filed: Jan. 12, 2007
(86) PCT No.: PCT/JP2007/050745

§ 371 Date: Apr. 29, 2008

(30) Foreign Application Priority Data
Jan. 16, 2006 (JP) 2006-007727

(51) Int. Cl. G02B 1/11; C08L 27/22; B32B 27/30; C08L 83/06

(52) U.S. Cl. 359/601; 525/104; 428/421

(57) ABSTRACT

A curable composition, which comprises at least one hydroxyl group-containing polymer, at least one crosslinking agent having a fluorine atom and being reactive with hydroxyl group and at least one curing catalyst; a compound having a specific structure, which is appropriately usable as a crosslinking agent in the curable composition, or a partial condensation product thereof; a cured product obtained by heating the curable composition; a laminate film or an antireflective film having a layer which is formed by coating the curable composition on a transparent support; a polarizing plate wherein the antireflective film is used as one of two protective films for a polarizing film in the polarizing plate; and an image display device wherein the antireflective film or the polarizing plate is employed as the outermost face of the display.

### TECHNICAL FIELD

This invention relates to a curable composition and a cured product, a laminate film and an antireflective film using the same, a polarizing plate using the antireflective film and an image display device using the antireflective film or the polarizing plate as the outermost face of the display.

### BACKGROUND ART

In an image display device such as a cathode ray tube (CRT), a plasma display panel (PDP), an electroluminescene display or a liquid crystal display device (LCD), an antireflective film is usually provided as the outermost face of the display and thus the refractive index is lowered based on the principle of optical interference to thereby prevent lowering in contrast and extraneous images caused by the reflection of outside light.

In general, such an antireflective film can be constructed by forming on a support a low refractive index layer having a refractive index lower than that of the support and an appropriate film thickness. To achieve a low refractive index, it is desirable that the low refractive index layer is made of a material having a refractive index as low as possible. Moreover, the antireflective film should have a high scratch resistance since it is employed as the outermost face of a display. To impart a high scratch resistance to a thin film having a thickness of about 100 nm, the film per se should have a high strength and a high adhesiveness to the layer just under it.

Means of lowering the refractive index of a material include (1) introducing a fluorine atom, (2) lowering the density (i.e., forming pores) and so on. By using these means, however, the film strength and the interfacial adhesiveness are lowered and, in its turn, the scratch resistance is worsened. Therefore, it is highly difficult to achieve both of a low refractive index and a high scratch resistance. To achieve a high scratch resistance, sufficient progress of a curing reaction is important. From the viewpoint of productivity, it is advantageous that a fluoropolymer is coated on a support followed and then the film is cured by some method. JP-A-11-228631, JP-A-2003-26732 and JP-A-2004-307524 propose methods of curing a low refractive index layer of an antireflective film by reacting a hydroxyl group in a fluoropolymer with a crosslinking agent with the use of an acid catalyst.

On the other hand, JP-T-7-505380, JP-A-2003-35961 and U.S. Pat. No. 3,296,264 report fluorine-containing melamine compounds and JP-A-2-258769, JP-A-2-258770 and JP-A-2-258820 report fluorine-containing guanamine compounds.

### DISCLOSURE OF THE INVENTION

Although a high curing activity can be achieved by the techniques reported by JP-A-11-228631, JP-A-2003-26732 and JP-A-2004-307524, a still lower refractive index is needed for improving the performance as an antireflective film. Thus, it has been required to establish both of a high curing activity and a low refractive index.

An object of the invention is to provide a curable composition which makes it possible to obtain a cured product having a high curing activity and a low refractive index. Another object of the invention is to provide a cured product, a laminate film and an antireflective film using this curable composition. Another object of the invention is to provide a polarizing plate and an image display device using the antireflective film.

As the results of intensive studies, the inventors have found out that a cured product having both of a high curing activity and a low refractive index can be produced and an antireflective film having a high scratch resistance and a low reflectivity can be formed by using a curable composition which contains at least one hydroxyl group-containing polymer, at least one crosslinking agent having a fluorine atom and being reactive with hydroxyl group and at least one curing catalyst.

According to the invention, the above-described objects have been accomplished by providing a curable composition having the following constitution, a cured product, a laminate film and an antireflective film using the curable composition, a polarizing plate using the antireflective film and an image display device using the antireflective film or the polarizing plate as the outermost face of the display.

(1) A curable composition, which comprises:

at least one hydroxyl group-containing polymer;

at least one crosslinking agent having a fluorine atom and being reactive with hydroxyl group; and

at least one curing catalyst.

(2) The curable composition as described in (1) above,

wherein the at least one hydroxyl group-containing polymer is a polymer containing at least one fluorine-containing vinyl monomer polymerization unit (a) and at least one hydroxyl group-containing vinyl monomer polymerization unit (b).

(3) The curable composition as described in (1) or (2) above,

wherein the at least one hydroxyl group-containing polymer contains a polysiloxane repeating unit represented by formula (1) in a main chain or a side chain thereof:

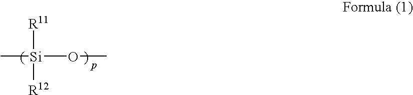

wherein R¹¹ and R¹² may be the same or different and each independently represents a substituted or unsubstituted alkyl or aryl group; and

p is an integer of from 1 to 500.

(4) The curable composition as described in any of (1) to (3) above,

wherein the at least one crosslinking agent has an aminoplast skeleton.

(5) The curable composition as described in any of (1) to (4) above,

wherein the at least one crosslinking agent is a compound represented by formula (2) or (3) or a partial condensation product thereof:

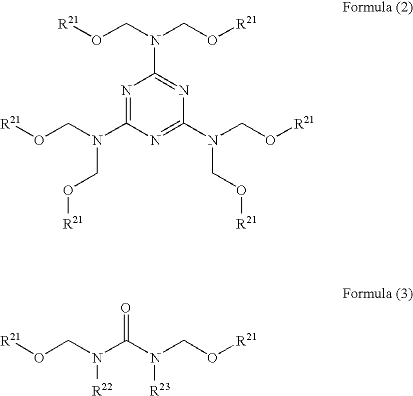

wherein R²¹'s each independently represents a hydrogen atom or an alkyl group optionally having a substituent, provided that at least one of R²¹'s is an alkyl group substituted by three or more fluorine atoms; and

R²² and R²³ each independently represents a hydrogen atom or an alkyl group optionally having a substituent, provided that R²² and R²³ may be bonded together to form a ring and R²² and R²³ may further form together a fused ring.

(6) A cured product obtained by heating a curable composition as described in any of (1) to (5) above.

(7) A laminate film, which comprises:

a transparent support; and

a layer that is formed by coating a curable composition as described in any of (1) to (5) above.

(8) An antireflective film, which comprises:

a transparent support; and

a low refractive index layer that is formed by coating a curable composition as described in any of (2) to (5) above.

(9) A polarizing plate, which comprises:

a polarizing film; and

at least two protective films for the polarizing film,

wherein at least one of the at least two protective films is an antireflective film as described in (8) above.

(10) An image display device, which comprises an antireflective film as described in (8) above or a polarizing plate as described in (9) above as the outermost face of the display.

(11) A compound represented by formula (2) or (3) or a partial condensation product thereof:

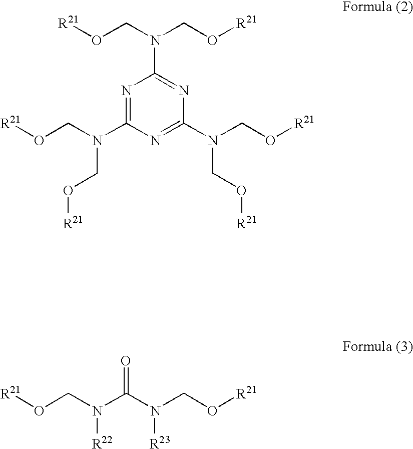

wherein R²¹'s each independently represents a hydrogen atom or an alkyl group optionally having a substituent, provided that at least one of R²¹'s is an alkyl group substituted by three or more fluorine atoms; and

R²² and R²³ each independently represents a hydrogen atom or an alkyl group optionally having a substituent, provided that R²² and R²³ may be bonded together to form a ring and R²² and R²³ may further form together a fused ring.

On the other hand, each of the fluorine-containing melamine compounds the fluorine-containing guanamine compounds described in JP-T-7-505380, JP-A-2003-35961, U.S. Pat. No. 3,296,264, JP-A-2-258769, JP-A-2-258770 and JP-A-2-258820 can serve as a crosslinking agent in the presence of an acid catalyst. In order to use in an antireflective film, however, the compound described in JP-T-7-505380 is disadvantageous because of having only a small number of crosslinking reaction groups. The compound described in JP-A-2003-35961 is also disadvantageous for this purpose because a highly active acid catalyst should be used in this case. Also, the compound described in U.S. Pat. No. 3,296,264 can only insufficiently contribute to the achievement of a low refractive index because of having only a small number of substituents in the fluoroalkyl group. Furthermore, the techniques described in JP-A-2-258769, JP-A-2-258770 and JP-A-2-258820 suffer from a disadvantage of requiring heating at a high temperature over long period of time.

### BRIEF DESCRIPTION OF THE DRAWING

FIG. 1A is a schematic sectional view showing the layer constitution of an exemplary embodiment of the antireflective film according to the invention; and FIG. 1B is a schematic sectional view showing the layer constitution of another exemplary embodiment of the antireflective film according to the invention,

wherein 1a denotes antireflective film; 1b denotes antireflective film; 2 denotes transparent support; 3 denotes hard coat layer; 4 denotes antiglare hard coat layer; 5 denotes low refractive index layer; 7 denotes medium refractive index layer; and 8 denotes high refractive index layer.

### BEST MODE FOR CARRYING OUT THE INVENTION

Next, the invention will be described in greater detail. In the case where a numerical value means a physical value, a characteristic value or the like, the expression “from (a numerical value 1) to (a numerical value 2)” as used herein means “(a numerical value) or more but not more than (a numerical value 2)”. The expression “on a support” as used herein involves both “directly on the surface of a support” and “on the surface of some layer (film) formed on a support”.

### <Curable Compositioin>

### [Crosslinking Agent]

The curable composition of the invention contains at least one crosslinking agent having a fluorine atom and being reactive with hydroxyl group. The crosslinking agent is not particularly restricted so long as it has a fluorine atom and a functional group capable of reacting with hydroxyl group. Concerning the skeleton, examples of the crosslinking agent include a polyisocyanate, a partial condensation product of an isocyanate compound, a polymer, an adduct with a polyhydric alcohol or a low molecular weight polyester film, a block polyisocyanate compound in which an isocyanate group is blocked with a blocking agent such as phenol, an aminoplast, a polybasic acid, an anhydride thereof and so on.

### [Aminoplast]

Among all, an aminoplast, which is capable of undergoing a crosslinking reaction with a hydroxyl group-containing compound under acidic conditions, is preferable in the invention from the viewpoints of the establishment of both of a high stability during storage and an activity in the crosslinking reaction and the strength of the resultant film. An aminoplast is a compound that has an amino group capable of reacting with a hydroxyl group contained in the hydroxyl group-containing polymer (i.e., a hydroxyalkylamino group or an alkoxyalkylamino group) or a carbon atom being adjacent to a nitrogen atom and substituted by an alkoxy group. As specific examples thereof, melamine-based compounds, urea-containing compound, benzoguanamine-based compounds and so on can be enumerated.

The melamine-based compounds are generally known as compounds having a skeleton in which a nitrogen atom is attached to a triazine ring. As specific examples thereof, melamine, an alkylated melamine, methylolmelamine, an alkoxylated methylmelamine and so on can be enumerated. In particular, methylolmelamine obtained by reacting melamine with formaldehyde under basic conditions, an alkoxylated methylmelamine and derivatives thereof are preferred. From the viewpoint of storage stability, an alkoxylated methylmelamine is particularly preferred. The methylol melamine and alkoxylated methylmelamine can be obtained by, for example, a method described in Purasuchikku Zairyo Koza [8], Yuria Meramin Jushi, Nikkan Kogyo Shinbin-sha, without particular restriction.

As the urea compound, it is preferable to use polymethylol urea and an alkoxylated methyl urea which is a derivative thereof and a compound having a cyclic urea structure such as a glycoluril structure or a 2-imidazolidinone structure, in addition to urea. As the amino compound such as a urea derivative as discussed above, it is also possible to use individual resins described in Yuria Meramin Jushi as cited above.

In the fluorine atom-containing compound to be used as a crosslinking agent in the invention, the number of the fluorine substituents is not particularly restricted, though the number of the substituents is preferably 2 or above, more preferably 3 of above, more preferably 4 or above and particularly preferably 6 or above.

From the viewpoints of the compatibility with the hydroxyl group-containing polymer (in particular, a hydroxyl group-containing fluoropolymer), easiness in synthesis and crosslinking density, it is preferable that the fluorine atom-containing compound to be used as a crosslinking agent in the invention is a compound represented by the following formula (2) or (3) or a partial condensation product thereof

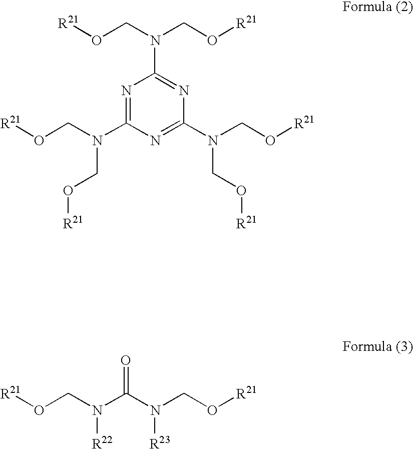

In the above formulae, R²¹'s each independently represents a hydrogen atom or an alkyl group optionally having a substituent, provided that at least one of R²¹'s is an alkyl group substituted by three or more fluorine atoms. R²² and R²³ each independently represents a hydrogen atom or an alkyl group optionally having a substituent, provided that R²² and R²³ may be bonded together to form a ring and they may further form together a fused ring.

In the case where R²¹ contains a fluorine atom, it is preferable that R²¹ is a fluoroalkyl group which preferably has from 2 to 10 carbon atoms, more preferably from 2 to 8 carbon atoms and more preferably from 2 to 6 carbon atoms.

In the case where R²¹ contains no fluorine atom, on the other hand, it represents a hydrogen atom or an alkyl group. This alkyl group preferably has from 2 to 10 carbon atoms, more preferably from 2 to 8 and more preferably from 2 to 6. Although it may have a substituent, an unsubstituted alkyl group is preferred.

R²² and R²³ each independently represents a hydrogen atom or an alkyl group optionally having a substituent. R²² and R²³ may be bonded together to form a ring and they may further form together a fused ring.

In the case where R²² and R²³ are bonded together to form a ring, a structure represented by the following formula (3-1) or the formula (3-2) is preferred.

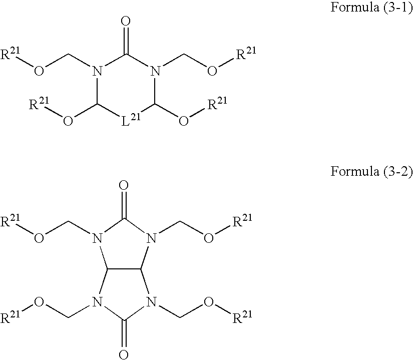

In the above formulae, R²¹ has the same meaning as defined above, L²¹ represents a single bond or a divalent linking group and a single bond is preferred. Examples of the divalent linking group include a methylene group optionally having a substituent, a dimethylene group, a trimethylene group, —O— and —NR²⁴—. A methylene group, a dimethylene group, and —O— are preferable and a methylene group is still preferable. R²⁴ represents a hydrogen atom or an alkyl group having from 1 to 6 carbon atoms.

Examples of the substituent which may be carried by the compounds represented by the formulae (2), (3), (3-1) and (3-2) include a hydroxyl group, a halogen atom (for example, Cl, Br or I), a cyano group, a nitro group, a carboxyl group, a sulfo group, a chain type or cyclic alkyl group having from 1 to 8 carbon atoms (for example, methyl, ethyl, isopropyl, n-butyl, n-hexyl, cyclopropyl, cyclohexyl, 2-hydroxyethyl, 4-carboxybutyl, 2-methoxyethyl or 2-diethylaminoethyl), an alkenyl group having from 1 to 8 carbon atoms (for example, vinyl, allyl or 2-hexenyl), an alkynyl group having from 2 to 8 carbon atoms (for example, ethynyl, 1-butynyl or 3-hexynyl), an aralkyl group having from 7 to 12 carbon atoms (for example, benzyl or phenethyl), an aryl group having from 6 to 10 carbon atoms (for example, phenyl, naphthyl, 4-carboxyphenyl, 4-acetamidophenyl, 3-methanesulfonamidophenyl, 4-methoxyphenyl, 3-carboxyphenyl, 3,5-dicarboxyphenyl, 4-methanesulfonamidophenyl or 4-butanesulfonamidophenyl), an acyl group having form 1 to 10 carbon atoms (for example, acetyl, benzoyl, propanoyl or butanoyl), an alkoxycarbonyl group having from 2 to 10 carbon atoms (for example, methoxycarbonyl or ethoxycarbonyl), an aryloxycarbonyl group having from 7 to 12 carbon atoms (for example, phenoxycarbonyl or naphthoxycarbonyl), a carbamoyl group having from 1 to 10 carbon atoms (for example, unsubstituted carbamoyl, methylcarbamoyl, diethylcarbamoyl or phenylcarbamoyl), an alkoxy group having from 1 to 8 carbon atoms (for example, methoxy, ethoxy, butoxy or methoxyethoxy), an aryloxy group having from 6 to 12 carbon atoms (for example, phenoxy, 4-carboxyphenoxy, 3-methylphenoxy or naphthoxy), an acyloxy group having from 2 to 12 carbon atoms (for example, acetoxy or benzoyloxy), a sulfonyloxy group having from 1 to 12 carbon atoms (for example, methylsulfonyloxy or phenylsulfonyloxy), an amino group having from 0 to 10 carbon atoms (for example, unsubstituted amino, dimethylamino, diethylamino or 2-carboxyethylamino), an acylamino group having from 1 to 10 carbon atoms (for example, acetamido or benzamido), a sulfonylamino group having from 1 to 8 carbon atoms (for example, methylsulfonylamino, phenylsulfonylamino, butylsulfonylamino or n-octylsulfonylamino), an ureido group having from 1 to 10 carbon atoms (for example, ureido or methylureido), an urethane group having from 2 to 10 carbon atoms (for example, methoxycarbonylamino or ethoxycarbonylamino), an alkylthio group having from 1 to 12 carbon atoms (for example, methylthio, ethylthio or octylthio), an arylthio group having from 6 to 12 carbon atoms (for example, phenylthio or naphthylthio), an alkylsulfonyl group having from 1 to 8 carbon atoms (for example, methylsulfonyl or butylsulfonyl), an arylsulfonyl group having from 7 to 12 carbon atoms (for example, phenylsulfonyl or 2-naphthylsulfonyl), a sulfamoyl group having from 0 to 8 carbon atoms (for example, unsubstituted sulfamoyl, methylsulfamoyl or the like), a heterocyclic group (for example, 4-pyridyl, piperidino, 2-furyl, furfuryl, 2-thienyl, 2-pyrrolyl or 2-quinolylmorpholino) and so on.

### [Method of Synthesizing Fluorine Atom-Containing Crosslinking Agent]

Next, a method of synthesizing a fluorine atom-containing crosslinking agent that is preferably used in the invention will be described.

Although a guanamine compound having a fluoroalkyl group, which is usable as a crosslinking agent, is described in, for example, JP-A-2-258769, JP-A-2-258770 and JP-A-2-258820, such a compound is synthesized by forming its skeleton with the use of a fluorine atom-containing material. Although this method may be used, it still suffers from some problems to be solved, e.g., involving many synthesis steps and requiring an expensive starting material. In the invention, it is preferable to use the compounds of the formulae (2) and (3), since they can be easily synthesized and starting materials thereof are relatively less expensive.

The above compound can be easily synthesized via an alcohol exchange reaction conducted by mixing an aminoplast with an excessive amount of a fluorine-containing alcohol in the presence of an acid catalyst. It is preferable that the aminoplast employed as the starting material has two or more sites, more preferably four or more sites, reactive with hydroxyl group.

It is preferable that the fluorine-containing alcohol has from 2 to 10 carbon atoms, more preferably from 2 to 8 and more preferably from 2 to 6 carbon atoms. The fluorine-containing alcohol is used preferably in an amount 5 times or more, more preferably 10 times or more and more preferably 20 times or more, as much as the mol number of the aminoplast.

As the acid catalyst, use can be preferably made of an organic acid such as a carboxylic acid, phosphonic acid or sulfonic acid or an inorganic acid such as hydrochloric acid, phosphoric acid or sulfuric acid. Among these acids, phosphonic acid, sulfonic acid, phoshoric acid or sulfuric acid is more preferable and sulfonic acid or sulfuric acid is more preferable. It is also preferred to add the acid catalyst in an amount of from 0.1 to 30% by mol, more preferably from 1 to 25% by mol and more preferably from 2 to 20% by mol, based on the aminoplast.

Although the reaction can be conducted at any temperature of from 0° C. to 140° C., it is preferable to conduct the reaction at a temperature of form 5° C. to 120° C., more preferably from room temperature to 100° C. Although the reaction time can be arbitrarily set, it is favorable to set the reaction time while monitoring the progress of the reaction by thin layer chromatography.

It remains unclear R²¹ at which site in the compound of the formula (2) or (3) thus formed is exchanged by a fluoroalkyl group. However, it can be understood by the NMR spectrum R²¹'s at how many sites have been exchanged by fluoroalkyl groups on average. The fluoroalkyl group-introduction rate (i.e., the rate of the number of the fluoroalkyl groups having been introduced to the number of the substituents capable of undergoing the alcohol exchange) preferably ranges from 10 to 90%, more preferably from 20 to 80% and more preferably from 30 to 70%.

Next, specific examples of the crosslinking agent having a fluorine atom as a substituent that can be preferably used in the invention will be listed, though the invention is not restricted thereto.

TABLE 1

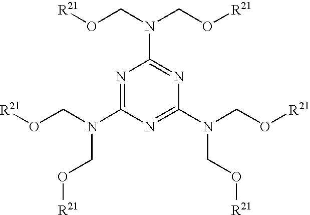

| Compound | |
|---|---|
| No. | R²¹ structure and rate |
| H-1 | CH₃/CH₂CF₃ = 70/30 |
| H-2 | CH₃/CH₂CF₃ = 60/40 |
| H-3 | CH₃/CH₂CF₃ = 50/50 |
| H-4 | CH₃/CH₂CF₃ = 35/65 |
| H-5 | CH₃/CH₂CF₂CF₃ = 58/42 |
| H-6 | CH₃/CH₂CF₂CF₃ = 52/48 |
| H-7 | CH₃/CH₂CF₂CF₃ = 41/59 |
| H-8 | CH₃/CH₂(CF₂)₄H = 55/45 |
| H-9 | CH₃/CH₂(CF₂)₄H = 50/50 |
| H-10 | C₄H₉/CH₂(CF₂)₄H = 40/60 |
| H-11 | CH₃/CH₂(CF₂)₂H = 70/30 |
| H-12 | CH₃/CH₂(CF₂)₂H = 55/45 |
| H-13 | CH₃/CH₂(CF₂)₂H = 45/55 |
| H-14 | CH₃/CH₂(CF₂)₆H = 50/50 |
| H-15 | CH₃/CH₂(CF₂)₆H = 42/58 |
| H-16 | CH₃/CH₂CH₂(CF₂)₄F = 48/52 |
| H-17 | CH₃/CH₂CH₂(CF₂)₆F = 45/55 |
| H-18 | C₄H₉/CH₂CH₂(CF₂)₈F = 45/55 |
| H-19 | CH₃/CH₂CF₂CHFCF₃ = 50/50 |
| H-20 | CH₃/CH₂CF(CF₃)O(CF₂)₃F = 50/50 |

TABLE 2

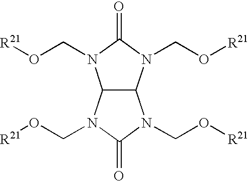

| Compound | |
|---|---|
| No. | R²¹ structure and rate |
| H-21 | CH₃/CH₂(CF₂)₂H = 65/35 |
| H-22 | CH₃/CH₂(CF₂)₂H = 45/55 |
| H-23 | CH₃/CH₂(CF₂)₄H = 60/40 |
| H-24 | CH₃/CH₂(CF₂)₄H = 50/50 |
| H-25 | CH₃/CH₂(CF₂)₆H = 44/56 |
| H-26 | CH₃/CH₂CF₃ = 60/40 |
| H-27 | CH₃/CH₂CF₃ = 53/47 |
| H-28 | CH₃/CH₂CF₃ = 44/56 |
| H-29 | CH₃/CH₂CF₂CF₃ = 50/50 |
| H-30 | CH₃/CH₂CF₂CF₃ = 58/42 |

TABLE 3

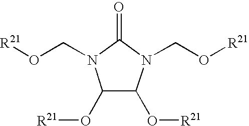

| Compound | |
|---|---|
| No. | R²¹ structure and rate |
| H-31 | CH₃/CH₂(CF₂)₂H = 65/35 |
| H-32 | CH₃/CH₂(CF₂)₂H = 45/55 |
| H-33 | CH₃/CH₂(CF₂)₄H = 60/40 |
| H-34 | CH₃/CH₂(CF₂)₆H = 59/41 |
| H-35 | CH₃/CH₂CF₃ = 85/15 |
| H-36 | CH₃/CH₂CF₃ = 75/25 |
| H-37 | CH₃/CH₂CF₃ = 60/40 |
| H-38 | CH₃/CH₂CF₃ = 48/52 |
| H-39 | CH₃/CH₂CF₂CF₃ = 55/45 |
| H-40 | CH₃/CH₂CF(CF₃)O(CF₂)₃F = 58/42 |

TABLE 4

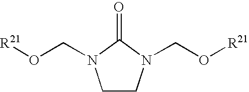

| Compound | |
|---|---|
| No. | R²¹ structure and rate |
| H-41 | CH₃/CH₂(CF₂)₂H = 54/46 |
| H-42 | CH₃/CH₂(CF₂)₄H = 45/55 |
| H-43 | CH₃/CH₂CF₃ = 50/50 |
| H-44 | CH₃/CH₂CF₂CF₃ = 59/41 |

TABLE 5

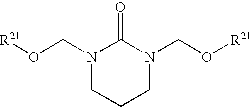

| Compound | |
|---|---|
| No. | R²¹ structure and rate |
| H-45 | CH₃/CH₂(CF₂)₂H = 61/39 |
| H-46 | CH₃/CH₂(CF₂)₄H = 49/51 |
| H-47 | CH₃/CH₂CF₃ = 53/47 |
| H-48 | CH₃/CH₂CF₂CF₃ = 45/55 |

TABLE 6

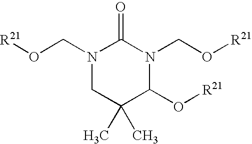

| Compound | |
|---|---|
| No. | R²¹ structure and rate |
| H-49 | CH₃/CH₂(CF₂)₂H = 34/66 |
| H-50 | CH₃/CH₂(CF₂)₄H = 47/53 |
| H-51 | CH₃/CH₂CF₃ = 62/38 |
| H-52 | CH₃/CH₂CF₂CF₃ = 55/45 |

TABLE 7

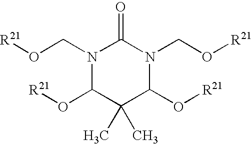

| Compound | |
|---|---|
| No. | R²¹ structure and rate |
| H-53 | CH₃/CH₂(CF₂)₂H = 72/28 |
| H-54 | CH₃/CH₂(CF₂)₄H = 62/38 |
| H-55 | CH₃/CH₂CF₃ = 55/45 |
| H-56 | CH₃/CH₂CF₂CF₃ = 50/50 |

TABLE 8

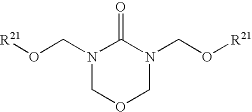

| Compound | |
|---|---|
| No. | R²¹ structure and rate |
| H-57 | CH₃/CH₂(CF₂)₂H = 47/53 |
| H-58 | CH₃/CH₂(CF₂)₄H = 50/50 |
| H-59 | CH₃/CH₂CF₃ = 55/45 |
| H-60 | CH₃/CH₂CF₂CF₃ = 52/48 |

TABLE 9

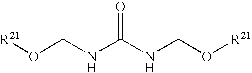

| Compound | |
|---|---|
| No. | R²¹ structure and rate |
| H-61 | CH₃/CH₂(CF₂)₂H = 50/50 |
| H-62 | CH₃/CH₂(CF₂)₄H = 60/40 |
| H-63 | CH₃/CH₂CF₃ = 51/49 |
| H-64 | CH₃/CH₂CF₂CF₃ = 23/77 |

TABLE 10

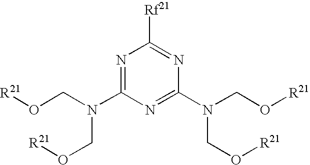

| Compound No. | R²¹ | Rf²¹ |
|---|---|---|
| H-65 | CH₃ | CH₂CF₂CF₃ |
| H-66 | CH₃ | CH₂(CF₂)₄F |
| H-67 | CH₃ | CH₂CH₂(CF₂)₆F |
| H-68 | C₄H₉ | CH₂(CF₂)₅F |

The ratio of the crosslinking agent to the hydroxyl group-containing polymer is from 1 to 70 parts by mass, preferably from 3 to 60 parts by mass and more preferably from 5 to 50 parts by mass, per 100 parts by mass of the polymer. When the content of the crosslinking agent is 1 part by mass or more, the resultant film can exhibit a satisfactory durability, i.e., the characteristic of the invention. It is also favorable that the content thereof is not more than 70 parts by mass, since a low refractive index (i.e., the characteristic of the low refractive index layer of the invention) can be maintained in the case of using for optical purpose. (In this specification, mass ratio is equal to weight ratio.)

### [Curing Catalyst]

In the invention, the film is cured by the crosslinking reaction between hydroxyl group of the hydroxyl group-containing polymer and the crosslinking agent. Since curing is promoted by an acid in this system, it is desirable to add an acidic substance to the curable composition. When a commonly employed acid is added thereto, however, the crosslinking reaction proceeds even in a coating solution and induce troubles (unevenness, repellency and so on). To establish both of a high storage stability and a high curing activity, therefore, it is preferable to add, as a curing catalyst, a compound capable of producing an acid upon heating in the case of employing heat curing or a compound capable of producing an acid upon photo irradiation in the cause of employing photocuring.

### (Curing Catalyst in Heat Curing System)

It is preferable that the catalyst to be used in the heat curing system is a salt formed by an acid and an organic base. Examples of the acid include an organic acid such as a sulfonic acid, phosphonic acid and a carboxylic acid and an inorganic acid such as sulfuric acid and phosphoric acid. From the viewpoint of the compatibility with the hydroxyl group-containing polymer, an organic acid is preferred, a sulfonic acid or phosphonic acid is more preferred and a sulfonic acid is most preferable. Examples of the preferable sulfonic acid include p-toluenesulfonic acid (PTS), benzenesulfonic acid (BS), p-dodecylbenzenesulfonic acid (DBS), p-chlorobenzenesulfonic acid (CBS), 1,4-napthalenedisulfonic acid (NDS), methanesulfonic acid (MsOH), nonafluorobutane-1-sulfonic acid (NFBS) and so on. Each of these sulfonic acids can be preferably employed. Abbreviations are in parenthesis.

The performance of a curing catalyst largely varies depending on the basicity and boiling point of the organic acid to be combined with an acid. Next, curing catalysts preferably usable in the invention will be illustrated from individual viewpoints.

From the viewpoint of the curing activity, a lower basicity is preferred since a higher acid production efficiency can be achieved thereby upon heating. When the basicity is too low, however, the storage stability becomes insufficient. Therefore, it is preferable to employ an organic base having an appropriate basicity. In the case of expressing the basicity with the use of pKa of conjugated acid as an indication, the pKa of the organic base to be used in the invention preferably ranges from 5.0 to 11.0, more preferably from 6.0 to 10.5 and more preferably from 6.5 to 10.0. pKa values of organic bases in aqueous solutions are listed in Kagaku Binran Kiso-hen (5th revised edition, edited by The Chemical Society of Japan, Maruzen, 2004), vol. 2 (II), pages 334 to 340. An organic base having an appropriate pKa can be selected from them. Moreover, use can be preferably made of a compound seemingly having an appropriate pKa, though it is not cited in the above document. Table 11 summarizes compounds having appropriate pKa values that are cited in the above document, though compounds preferably usable in the invention are not restricted thereto.

TABLE 11
Organic base

| No. | Chemical name | pKa |
|---|---|---|
| b-1 | N,N-Dimethylaniline | 5.1 |
| b-2 | Benzimidazole | 5.5 |
| b-3 | Pyridine | 5.7 |
| b-4 | 3-Methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-Dimethylamino)pyridine | 6.5 |
| b-10 | 2,6-Diemthylpyridine | 7.0 |
| b-11 | Imidazole | 7.0 |
| b-12 | 2-Methylimidazole | 7.6 |
| b-13 | N-Ethylmorpholine | 7.7 |
| b-14 | N-Methylmorpholine | 7.8 |
| b-15 | Bis(2-methoxyethyl)amine | 8.9 |
| b-16 | 2,2′-Iminodiethanol | 9.1 |
| b-17 | N,N-Dimethyl-2-aminoethanol | 9.5 |
| b-18 | Trimethylamine | 9.9 |
| b-19 | Triethylamine | 10.7 |

From the viewpoint of the curing activity, a lower boiling point is preferred since a higher acid production efficiency can be achieved thereby upon heating. Thus, it is preferred to employ an organic base having an appropriate boiling point. The boiling point of the base is preferably 120° C. or lower, more preferably 80° C. or lower and more preferably 70° C. or lower.

Examples of an organic base preferably usable in the invention include the following compounds, though the invention is not restricted thereto. Each numerical value shown in parentheses indicates boiling points.

b-3: Pyridine (115° C.), b-14: 4-methylmorpholine (115° C.), b-20: diallylmethylamine (111° C.), b-19: triethylamine (88.8° C.), b-21: t-butylmethylamine (67 to 69° C.), b-22: dimethylisopropylamine (66° C.), b-23: diethylmethylamine (63 to 65° C.), b-24: dimethylethylamine (36 to 38° C.) and b-18: trimethylamine (3 to 5° C.).

To use as the curing catalyst in the invention, the above-described salt formed by an acid with an organic base may be isolated before using. Alternatively, it is possible to use a solution which is prepared by mixing the acid with the organic base and form the salt in the solution. Also, use may be made of either one acid and one organic base or a mixture of multiple acids and organic bases. In the case of using a mixture of an acid with an organic base, it is preferable to mix them to give an equivalent ratio of the acid to the organic base of 1:0.9 to 1.5, more preferably 1:0.95 to 1.3 and more preferably 1:1.0 to 1.1.

This acid catalyst is used in an amount of preferably from 0.01 to 10 parts by mass, more preferably from 0.1 to 5 parts by mass and more preferably from 0.2 to 3 parts by mass, per 100 parts by mass of the hydroxyl group-containing polymer (preferably a hydroxyl group-containing fluoropolymer) in the curable composition as discussed above.

### (Curing Catalyst in Photocuring System)

In a photocuring system, it is preferable to use a compound which produces an acid upon photo irradiation, i.e., a photosensitive acid-producing agent as the curing catalyst. The photosensitive acid-producing agent is a substance that imparts photosensitivity to a coating film of the curable composition and thus enables photocuring of the coating film upon irradiation with radiation such as light. As this photosensitive acid-producing agent, use can be made of, for example, (1) various onium salts such as an iodonium salt, a sulfonium salt, a phosphonium salt, a diazonium salt, an ammonium salt and a pyridinium salt; (2) sulfone compounds such as a β-ketoester, a β-sulfonylsulfone and α-diazo compounds thereof, (3) sulfonic esters such as an alkyl sulfonate, a haloalkyl sulfonate, an aryl sulfonate and an imino sulfonate; (4) sulfonimide compounds; (5) diazomethane compounds; and so on and these compounds can be appropriately employed.

Either one photosensitive acid-producing agent or a combination of two or more thereof may be used. It is also possible to use the photosensitive acid-producing agent together with a heat acid-producing agent as described above. The photosensitive acid-producing agent is used in an amount of preferably from 0 to 20 parts by mass, more preferably from 0.1 to 10 parts by mass per 100 parts by mass of the hydroxyl group-containing polymer (preferably a hydroxyl group-containing fluoropolymer) in the curable composition as discussed above. It is favorable that the content of the photosensitive acid-producing agent is not more than the upper limit as specified above, since the resultant cured product has an excellent strength and a high transparency.

### [Hydroxyl Group-Containing Polymer]

The hydroxyl group-containing polymer to be used in the invention is not particularly restricted, so long as it contains a hydroxyl group. Concerning of the polymer skeleton, examples thereof include (meth)acrylic polymers, polyesters, polycarbonates, polyamides, polyurethanes, polyolefins, polyvinyl alcohols, polyvinyl acetals, fluoroolefin polymers and cellulose derivatives. Also, hydroxyl group may be introduced into the polymer by an arbitrary method without restriction. Examples thereof include a method of conducting polymerization with the use of a constitutional unit having a hydroxyl group, a method of deriving a hydroxyl group-containing polymer from a polymer having a functional group which can be converted into a hydroxyl group. Since the crosslinking agent to be used in the invention has the characteristic of lowering the refractive index of the cured product, this characteristic can be fully exerted when combined with a polymer having a low refractive index.

### [Fluoropolymer]

In the invention, a coating film having a lower refractive index, which is useful in, for example, an antireflective film, can be formed by using a hydroxyl group-containing fluoropolymer. Next, the hydroxyl group-containing fluoropolymer will be illustrated.

{Fluorine-Containing Vinyl Monomer Polymerization Unit (a)}

A polymerization unit based on a fluorine-containing vinyl monomer (hereafter called a fluorine-containing vinyl monomer polymerization unit (a)) contained in the hydroxyl group-containing fluoropolymer (hereinafter merely called “fluoropolymer” in some cases) to be used in forming a cured film in the invention is not restricted in structure. Examples thereof include polymerization units based on a fluoroolefin, a perfluoroalkyl vinyl ether, a vinyl ether or (meth)acrylate having a fluoroalkyl group and so on. From the viewpoints of the suitability for production and characteristics required for a low refractive index layer (refractive index, film strength, etc.), it is preferable that the fluoropolymer is a copolymer of a fluoroolefin with a vinyl ether and a copolymer of a perfluoroolefin with a vinyl ether is still preferred. To lower the refractive index, it may further contain, as a copolymerization component, a unit based on a perfluoroalkyl vinyl ether, a vinyl ether or (meth)acrylate having a fluoroalkyl group and so on.

It is preferable that the perfluoroolefin has from 3 to 7 carbon atoms. From the viewpoint of polymerization reactivity, perfluoropropylene or perfluorobutylene is preferred. From the viewpoint of availability, perfluoropropylene is particularly preferred.

It is preferable that the content of the perfluoroolefin in the polymer is from 25 to 75% by mol. To lower the refractive index of a material, it is desirable to introduce the perfluoroolefin at an elevated ratio. In a radical polymerization in a solution system that is commonly employed because of the high polymerization reactivity, however, the upper limit of the introduction ratio thereof is about 50 to 70% by mol. Namely, the perfluoroolefin can be hardly introduced at a higher ratio. In the invention, the content of the perfluoroolefin is preferably from 30% to 70% by mol, more preferably from 30% to 60% by mol, more preferably from 35% to 60% by mol and particularly preferably from 40 to 60% by mol.

To lower refractive index, the fluoropolymer to be used in the invention may be copolymerized with a perfluorovinyl ether represented by the following formula M2. This copolymerization component may be introduced into the polymer at a ratio of from 0 to 40% by mol, preferably from 0 to 30% by mol and more preferably from 0 to 20% by mol.

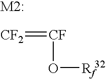

In the formula M2, Rf³² represents a fluoroalkyl group having from 1 to 30 carbon atoms, preferably a fluoroalkyl group having from 1 to 20 carbon atoms and particularly preferably from 1 to 10 carbon atoms and still preferably a perfluoroalkyl group having from 1 to 10 carbon atoms, provided that the fluoroalkyl group may have a substituent. Specific examples of Rf³² include —CF₃{M2-(1)}, —CF₂CF₃{M2-(2)}, —CF₂CF₂CF₃{M2-(3)}, —CF₂CF(OCF₂CF₂CF₃)CF₃{M2-(4)} and so on.

To lower refractive index, it is also possible in the invention to copolymerize a fluorovinyl ether represented by the following formula M1. This copolymerization component may be introduced into the polymer at a ratio of from 0 to 40% by mol, preferably from 0 to 30% by mol and more preferably from 0 to 20% by mol.

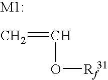

In the formula M1, Rf³¹ represents a fluoroalkyl group having from 1 to 30 carbon atoms, preferably a fluoroalkyl group having from 1 to 20 carbon atoms and particularly preferably from 1 to 15 carbon atoms. It may have either a linear structure {for example, —CF₂CF₃, —CH₂(CF₂)_{q1}H, —CH₂CH₂(CF₂)_{q1}F (q1: an integer of from 2 to 12) and so on}, a branched structure {for example, CH(CF₃)₂, CH₂CF(CF₃)₂, —CH(CH₃)CF₂CF₃, —CH(CH₃)(CF₂)₅CF₂H and so on}, or an alicyclic structure (preferably a 5-membered or 6-membered ring such as a perfluorocyclohexyl group, a perfluorocyclopentyl group or an alkyl group substituted by such a group and so on). Moreover, it may have an ether bond (for example, —CH₂OCH₂CF₂CF₃, —CH₂CH₂OCH₂(CF₂)_{q2}H, —CH₂CH₂OCH₂(CF₂)_{q2}F (q2: an integer of from 2 to 12), CH₂CH₂OCF₂CF₂OCF₂CF₂H and so on). The substituent represented by Rf³¹ is not restricted to the substituents cited herein.

The monomer represented by the formula M1 can be synthesized by, for example, a method comprising treating a leaving group-substituted alkyl vinyl ether (for example, a vinyloxyalkyl sulfonate or a vinyloxyalkyl chloride) with a fluorine-containing alcohol in the presence of a base as described in “Macromolecules”, vol. 32(21), p. 7122 (1999) and JP-A-2-721; a method comprising mixing a fluorine-containing alcohol with a vinyl ether such as butyl vinyl ether in the presence of a palladium catalyst to thereby exchange the vinyl group as described in International Patent Application 92/05135; a method comprising reacting a fluoroketone with dibromoethane in the presence of a potassium fluoride catalyst and then conducting a reaction for removing HBr with the use of an alkali catalyst as described in U.S. Pat. No. 3,420,793, or the like.

{Hydroxyl Group-Containing Vinyl Monomer Polymerization Unit (b)}

The fluoropolymer to be used in the invention contains a polymerization unit based on a hydroxyl group-containing vinyl monomer (hereafter called a hydroxyl group-containing vinyl monomer polymerization unit (b)) and the content thereof is not particularly restricted. Since a hydroxyl group reacts with a crosslinking agent and thus hardens, a higher hydroxyl group content is preferred because of forming a harder film. The content thereof is preferably 10% by mol or more but not more than 70% by mol, more preferably more than 20% by mol but not more than 60% by mol and more preferably 25% by mol or more but not more than 55% by mol.

The hydroxyl group-containing vinyl monomer may be selected from among, for example, vinyl ethers, (meth)acrylates, styrenes and so on without specific restriction, so long as it is copolymerizable with the fluorine-containing vinyl monomer as described above. In the case of using a perfluoroolefin (e.g., hexafluoropropylene) as the fluorine-containing vinyl monomer, for example, it is preferred to use a hydroxyl group-containing vinyl ether having a favorable copolymerizability and specific examples thereof include 2-hydroxyethyl vinyl ether, 4-hydroxybutyl vinyl ether, 6-hydroxyhexyl vinyl ether 8-hydroxyoctyl vinyl ether, diethylene glycol vinyl ether, triethylene glycol vinyl ether, 4-(hydroxymethyl)cyclohexylmethyl vinyl ether and so on, though the invention is not restricted thereto.

### [Polysiloxane Repeating Unit-Containing Polymer]

To impart stain proofness, it is also preferable in the invention that the hydroxyl group-containing polymer (preferably a hydroxyl group-containing fluoropolymer) contains a constitutional unit having a polysiloxane structure. As the hydroxyl group-containing polymer useful in the invention, citation may be made of a polymer which contains at least one each of (a) a fluorine-containing vinyl monomer polymerization unit, (b) a hydroxyl group-containing vinyl monomer polymerization unit and (c) a polymerization unit having a graft site containing a polysiloxane repeating unit represented by the following formula (1) and the main chain of which exclusively consists of carbon atoms, or a polymer which contains at least one each of (a) a fluorine-containing vinyl monomer polymerization unit and (b) a hydroxyl group-containing vinyl monomer polymerization unit together with (d) a polysiloxane repeating unit represented by the following formula (1) in the main chain thereof

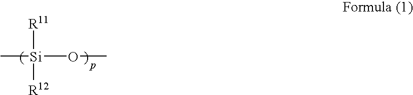

In the formula (1), R¹¹ and R¹² may be either the same or different and each represents a substituted or unsubstituted alkyl or aryl group. As the alkyl group, one having from 1 to 4 carbon atoms is preferable and examples thereof include a methyl group, a trifluoromethyl group, an ethyl group and so on. As the aryl group, one having from 6 to 20 carbon atoms is preferable and examples thereof include a phenyl group and a naphthyl group. p is an integer of from 1 to 500, preferably from 5 to 500, more preferably from 8 to 350 and particularly preferably from 10 to 250.

### (Polymerization Unit Having Polysiloxane Repeating Unit in Side Chain)

The hydroxyl group-containing polymer having a repeating structure represented by the following formula (1) in its side chain can be synthesized by, for example, a method comprising introducing, into a polymer having a reactive group (for example, an epoxy group, a hydroxyl group, a carboxyl group, an acid anhydride group or the like), a polysiloxane having a reactive group suitable therefor (for example, an amino group, a mercapto group, a carboxyl group, a hydroxyl group, etc. for the epoxy group or the acid anhydride group) at one end (for example, SILAPLANE series manufactured by Chisso Corporation) as described in J. Appl. Polym. Sci., vol. 2000, p. 78 (1995) and JP-A-56-28219 or a method comprising polymerizing a polysiloxane-containing silicone macromer. Each of these methods may be preferably employed. In the present invention, the introduction method comprising polymerizing a polysiloxane-containing silicone macromer is preferred.

As the silicone macromer, use may be made of any one so long as it has a polymerizable group capable of undergoing copolymerization with a fluorine-containing olefin. A structures represented by any one of the following formulae (I-1) to (I-4) is preferable therefor.

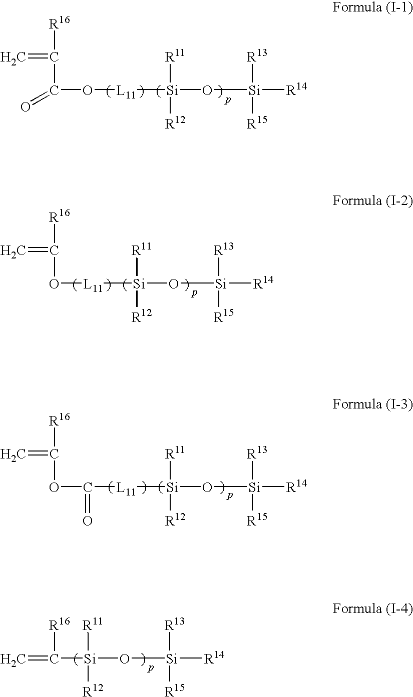

In the formulae (I-1) to (1-4), R¹¹, R¹² and p have each the same meaning as in the formula (1) and preferable ranges are also the same. R¹³ to R¹⁵ independently represent each a substituted or unsubstituted monovalent organic group or a hydrogen atom. Preferable examples thereof include an alkyl group having from 1 to 10 carbon atoms (for example, a methyl group, an ethyl group, an octyl group and so on), an alkoxy group having from 1 to 10 carbon atoms (for example, a methoxy group, an ethoxy group, an propyloxy group and so on) and an aryl group having from 6 to 20 carbon atoms (for example, a phenyl group, a naphthyl group and so on), and an alkyl group having from 1 to 5 carbon atoms is particularly preferable. R¹⁶ represents a hydrogen atom or a methyl group. L¹¹ represents an arbitrary linking group having from 1 to 20 carbon atoms. Examples thereof include a substituted or unsubstituted and linear, branched or alicyclic alkylene group and a substituted or unsubstituted arylene group. An unsubstituted alkylene group having from 1 to 20 carbon atoms is preferable and an ethylene group or a propylene group is particularly preferable. Such a compound can be synthesized by, for example, a method described in JP-A-6-322053.

Any one of the compounds represented by the formulae (I-1) to (I-4) may be preferably used in the invention. Among them, one having a structure represented by the formula (I-1), (I-2) or (I-3) is preferable from the viewpoint of the copolymerization properties with the fluoroolefin. The content of the polymerization unit having a graft site containing a polysiloxane repeating unit as described above preferably amounts to 0.01 to 20% by mass, more preferably 0.05 to 15% by mass and particularly preferably 0.5 to 10% by mass, based on the graft copolymer.

Next, preferable examples of the polymerization unit having a graft site containing a polysiloxane repeating unit in its side chain will be presented, though the invention is not restricted thereto.

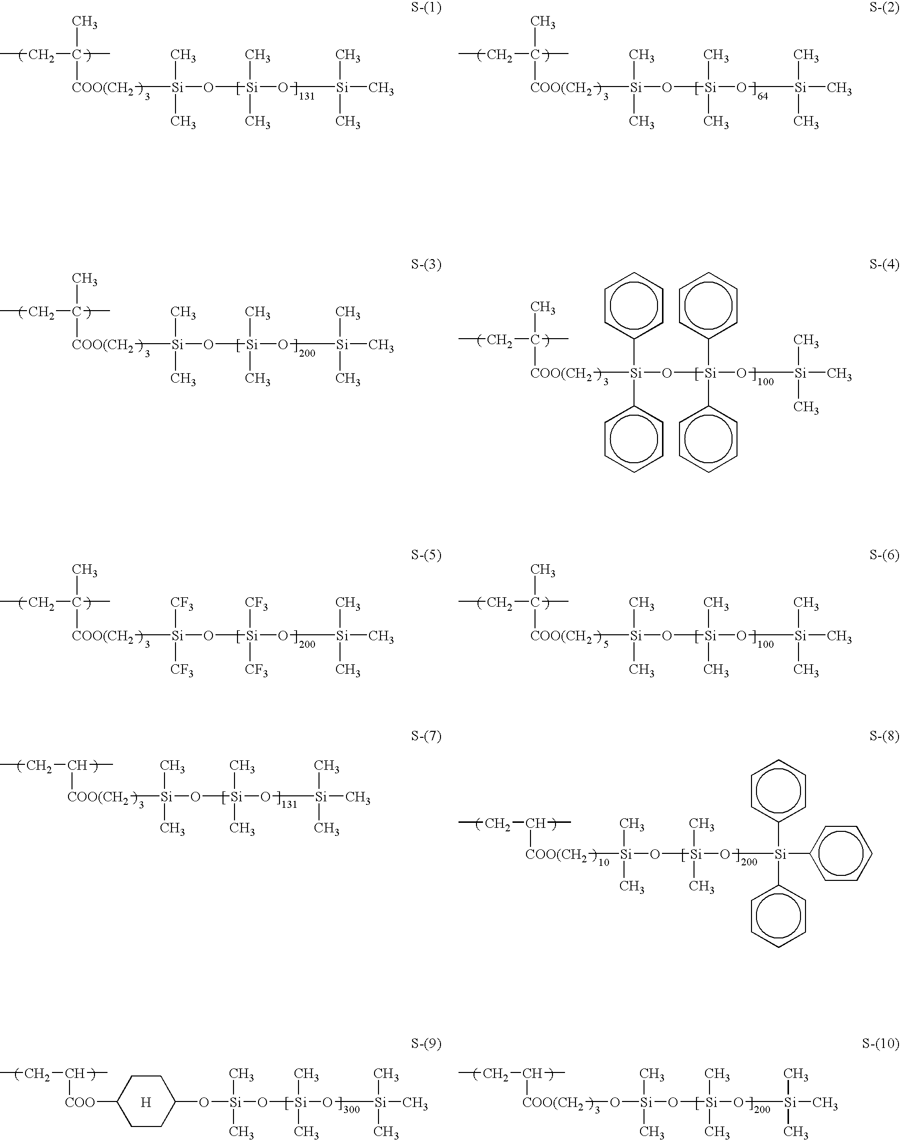

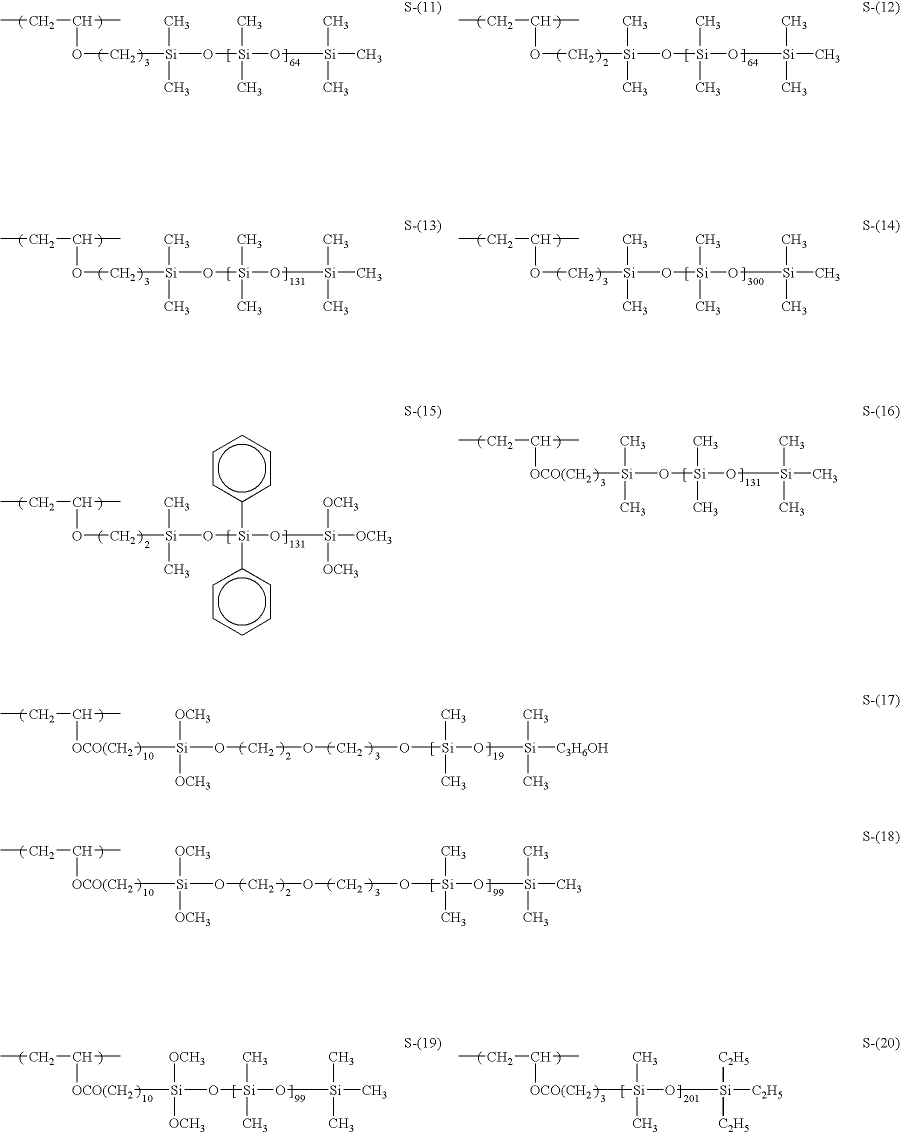

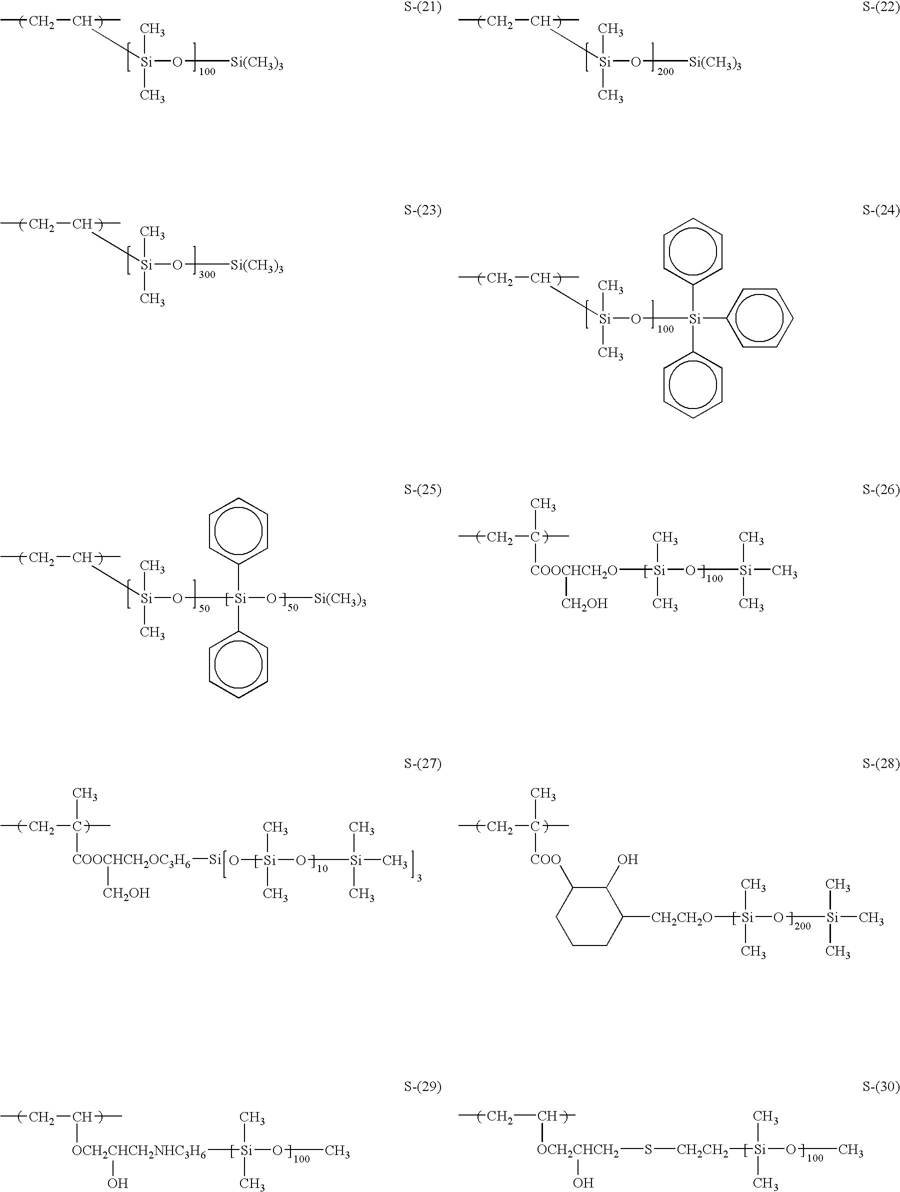

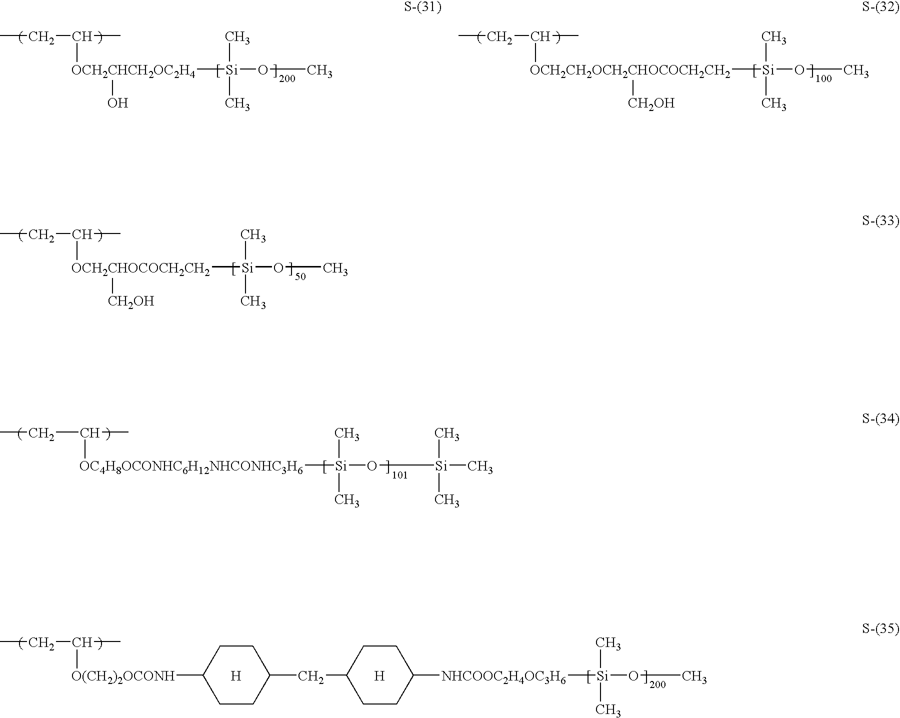

S-(36): “SILAPLANE FM-0711” (manufactured by Chisso Corporation)

### S-(37): “SILAPLANE FM-0731” (do.)

### S-(38): “SILAPLANE FM-0725” (do.)

### (Polysiloxane Repeating Unit Contained in Main Chain)

In the invention, use may be made preferably of a hydroxyl group-containing polymer having a polysiloxane structure represented by the formula (1) in its side chain (preferably a polymer which contains at least one each of (a) a fluorine-containing vinyl monomer polymerization unit and (b) a hydroxyl group-containing vinyl monomer polymerization unit together with (d) a polysiloxane repeating unit represented by the following formula (1) in the main chain thereof) as a substitute for the hydroxyl group-containing polymer containing a polysiloxane repeating unit as described above.

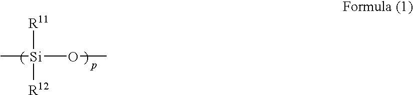

In the above formula (1), R¹¹ and R¹² are the same as defined in R¹¹ and R¹² in the above-described formula (1) concerning the hydroxyl group-containing polymer having a having a polysiloxane repeating unit in a side chain and the preferable ranges are also the same.

The polysiloxane structure may be introduced into the main chain by an arbitrary method without restriction. For example, use can be made of a method with the use of a polymer type initiator such as an azo group-containing polysiloxanamide as described in JP-A-6-93100, a method which comprises introducing a reactive group derived from a polymerization initiator or a chain transfer agent (for example, a mercapto group, a cabroxyl group, a hydroxyl group, etc.) into an end of a polymer and then reacting a polysiloxane having reactive group(s) (for example, an epoxy group, an isocyanate group, etc.) at one or both ends, a method which comprises copolymerizing a cyclic siloxane oligomer such as hexamethylcyclotrisiloxane by ring-opening polymerization, and so on. Among all, the method with the use of an initiator having a polysiloxane structure is preferable because of its convenience.

As the polysiloxane structure to be introduced into the main chain of the hydroxyl group-containing polymer to be used in the invention, a structure represented by the formula (4) is particularly preferred.

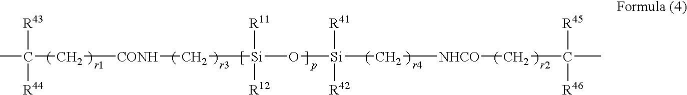

In the formula (4), R¹¹, R¹², R⁴¹ and R⁴² independently represent each an alkyl group (preferably having from 1 to 5 carbon atoms such as a methyl group or an ethyl group) or an aryl group (preferably having from 6 to 10 carbon atoms such as a phenyl group or a naphthyl group) which may further has a substituent. A methyl group or naphthyl group is preferable and a methyl group is particularly preferable.

R⁴³ to R⁴⁶ independently represent each a hydrogen atom, an alkyl group (preferably having from 1 to 5 carbon atoms such as a methyl group or an ethyl group), an aryl group preferably having from 6 to 10 carbon atoms such as a phenyl group or a naphthyl group), an alkoxycarbonyl group (preferably having from 2 to 5 carbon atoms such as a methoxycarbonyl group or an ethoxycarbonyl group) or a cyano group. An alkyl group, an alkoxycarbonyl group and a cyano group are preferable and a methyl group and a cyano group are more preferable.

r1 and r2 independently represent each an integer of from 1 to 10, preferably an integer of from 1 to 6 and particularly preferably an integer of from 2 to 4. r3 and r4 independently represent each an integer of from 0 to 10, preferably an integer of from 1 to 6 and particularly preferably an integer of from 2 to 4. p represents an integer of from 1 to 500, preferably from 5 to 500, more preferably from 8 to 350 and particularly preferably from 10 to 250.

Commercially available macrozao initiators “VPS-0501™”, and “VPS-1001™” (manufactured by Wako Pure Chemical Industries) are compounds in which several units falling within the category of the formula (4) are bonded together via azo groups. It is preferable to use such a compound as an initiator, since the above-described units can be introduced into the polymer thus obtained.

It is preferable that the polysiloxane structure as described above is introduced into the hydroxyl group-containing polymer to be used in the invention at a ratio of from 0.01 to 20% by mass, more preferably from 0.05 to 15% by mass and particularly preferably from 0.5 to 10% by mass.

Owing to the polysiloxane structure thus introduced, stain proofness and dust proofness can be imparted to a coating film and, moreover, slipperiness can be imparted to the film surface, which is advantageous from the viewpoint of scratch resistance.

### (Other Polymerization Units)

Copolymerization components other than those described above can be appropriately selected by considering hardness, adhesiveness to a base, solubility in a solvent, transparency and so on. As examples thereof there can be enumerated vinyl ethers such as methyl vinyl ether, ethyl vinyl ether, t-butyl vinyl ether, n-butyl vinyl ether, cyclohexyl vinyl ether and isopropyl vinyl ether and vinyl esters such as vinyl acetate, vinyl propionate, vinyl butyrate and vinyl cyclohexanecarboxylate. Such a copolymerization components is introduced in an amount of from 0 to 40% by mol, preferably from 0 to 30% by mol and particularly preferably from 0 to 20% by mol.

### (Form of Preferable Hydroxyl Group-Containing Polymer)

In the invention, a polymer in the form represented by the following formula (5) is particularly preferred.

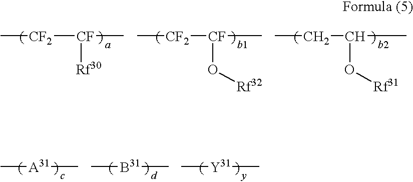

In the formula (5), Rf³⁰ represents a perfluoroalkyl group having from 1 to 5 carbon atoms. In the monomer constituting the part represented by —CF₂CF(Rf³⁰), examples of the perfluoroolefin are the same as those cited above. Rf³² has the same meaning as defined with respect to the above fluorine-containing vinyl ether (Rf³² in the compound represented by the above formula M2) and preferable ranges are also the same. Rf³¹ has the same meaning as defined with respect to the other fluorine-containing vinyl ether (Rf³¹ in the compound represented by the above formula M1) and preferable ranges are also the same.

A³¹ and B³¹ respectively represent a hydroxyl group-containing vinyl monomer polymerization unit and an arbitrary constitutional unit. A³¹ has the same meaning as the hydroxyl group-containing vinyl monomer polymerization unit described above. Although B³¹ is not particularly restricted, preferable examples thereof include polymerization units based on vinyl ethers and vinyl esters from the viewpoint of copolymerization properties. More specifically speaking, there can be enumerated the monomers cited above as examples in (Other polymerization units).

Y³¹ represents a constitutional unit having a polysiloxane structure. It may be in the form of either a polymerization unit having a graft site containing a polysiloxane repeating unit represented by the above-described formula (1) or a polymerization unit containing a polysiloxane repeating unit represented by the formula (1) in its main chain. The definitions and preferable ranges thereof are the same as those described above with respect to [Polysiloxane repeating unit-containing polymer].

a to d represent each the molar ratio of the respective constitutional components, provided that a+b1+b2+c=100 and each satisfies the following requirement: 30≦a≦70 (preferably 30≦a≦60 and more preferably 35≦a≦60), 0≦b1≦40 (preferably 0≦b1≦30 and more preferably 0≦b1≦20), 0≦b2≦40 (preferably 0≦b2≦30 and more preferably 0≦b2≦20), 10≦c≦70 (preferably 20≦c≦60 and more preferably 25≦c≦55) and 0≦d≦40 (preferably 0≦d≦30).

y represents the mass ratio (%) of the constitutional unit having a polysiloxane structure to the whole hydroxyl group-containing polymer and satisfies the following requirement: 0.01≦y≦20 (preferably 0.05≦y≦15 and more preferably 0.5≦y≦10).

The number-average molecular weight of the hydroxyl group-containing polymer to be used in the curable composition of the invention ranges preferably from 5,000 to 1,000,000, more preferably from 8,000 to 500,000 and particularly preferably from 10,000 to 100,000.

The number-average molecular weight as described herein is a value expressing the molecular weight in terms of polystyrene which is determined with a GPC analyzer with the use of TSKgel GMHxL, TSKgegl G4000HxL and TSKgel G2000HxL (each manufactured by TOSO Co., Ltd.), tetrahydrofuran (THF) as a solvent and a differential refractometer for detection.

The following table shows specific examples of polymers useful in the invention, though the invention is not restricted thereto. In this table, each polymer is shown as a combination of copolymerization components used for forming the polymer.

TABLE 12

| | | Fluoropolymer | | | | | | | | | | | |
|---|---|---|---|---|---|---|---|---|---|---|---|---|---|
| | | P1 | P2 | P3 | P4 | P5 | P6 | P7 | P8 | P9 | P10 | P11 | P12 |
| constitutional | HFP | 50 | 50 | 50 | 50 | 50 | 50 | 50 | 45 | 50 | 50 | 50 | 50 |
| component (A) | M1-(1) | | | | | | | | | | 15 | | 10 |
| | M1-(2) | | | | | | | | | | | 15 | |
| | M2-(3) | | | | | | | | | | | | |
| | HEVE | 50 | 50 | 50 | 40 | 40 | 40 | 33 | 35 | 32 | | | |
| | HBVE | | | | | | | | | | 35 | 35 | 15 |
| | HOVE | | | | | | | | | | | | |
| | DEGVE | | | | | | | | | | | | |
| | HMcHVE | | | | | | | | | | | | |
| | EVE | | | | 10 | 10 | 10 | 17 | 20 | 18 | | | 25 |
| | cHVE | | | | | | | | | | | | |
| | tBuVE | | | | | | | | | | | | |
| | VAc | | | | | | | | | | | | |
| Polysiloxane- | FM-0721 | | | | | | 6 | | | 4.2 | | | 4 |
| Containing | FM-0725 | | 1.7 | | 4.9 | | | | | | | | |
| constitutional | VPS-0501 | | | | | 3.4 | | | | | 1.7 | | |
| component | VPS-1001 | | | 2.7 | | | | | 3.5 | | | | |

| | | | | | | | | | | | | |
|---|---|---|---|---|---|---|---|---|---|---|---|---|
| Number-average | 1.5 | 1.7 | 2.1 | 4.5 | 2.8 | 2.5 | 2.3 | 3.5 | 1.2 | 2.5 | 1.4 | 3.2 |
| M.W.(×10⁴) | | | | | | | | | | | | |

TABLE 13

| | | Fluoropolymer | | | | | | | | | | | |
|---|---|---|---|---|---|---|---|---|---|---|---|---|---|
| | | P13 | P14 | P15 | P16 | P17 | P18 | P19 | P20 | P21 | P22 | P23 | P24 |
| constitutional | HFP | 50 | 50 | 50 | 50 | 40 | 50 | 45 | 50 | 50 | 50 | 50 | 40 |
| component (A) | M1-(1) | | | 5 | | | 10 | | | | | | |
| | M1-(2) | | | | | | | | | | | | 10 |
| | M2-(3) | | | | | 10 | | 5 | | | | | |
| | HEVE | | | | | | | | | | | | |
| | HBVE | | | | | | | | | | | | |
| | HOVE | 13 | 35 | 40 | 35 | | | | | | | | |
| | DEGVE | | | | | 40 | 25 | 15 | 30 | | | | |
| | HMcHVE | | | | | | | | | 40 | 25 | 25 | 35 |
| | EVE | | | | 15 | 10 | | | | 10 | | | |
| | cHVE | 37 | | | | | | | 20 | | 25 | | |
| | tBuVE | | | 5 | | | 15 | | | | | 10 | 15 |
| | VAc | | 15 | | | | | 35 | | | | 15 | |
| Polysiloxane- | FM-0721 | | | | 5 | | | | | | | | |
| Containing | FM-0725 | | | 4.1 | | 3.6 | | | | 2.9 | 7.3 | | 4.8 |
| constitutional | VPS-0501 | 5 | | | | | | 8 | | | | | |
| component | VPS-1001 | | 4.9 | | | | 0.9 | | 9.7 | | | | |

| | | | | | | | | | | | | |
|---|---|---|---|---|---|---|---|---|---|---|---|---|
| Number-average | 2.6 | 3.4 | 3.9 | 2.9 | 3.5 | 2.8 | 3.1 | 4.5 | 3.6 | 4.2 | 1.8 | 4.5 |
| M.W.(×10⁴) | | | | | | | | | | | | |

In the above tables, for the sake of simplicity, the copolymerization components other than the polysiloxane-containing constitutional component are described in row “constitutional component (A)”. With respect to the constitutional components described in the raw (A), the molar ratio of each component is shown. The abbreviations have the following meanings.

HFP: hexafluoropropylene

### M1-(1): CH₂═CH—O—CH₂CH₂OCH₂CH₂(CF₂)₄F

### M1-(2): CH₂═CH—O—CH₂CH₂OCH₂(CF₂)₆H

### M1-(3): CF₂═CF—O—CF₂CF₂CF₃

HEVE: 2-hydroxyethyl vinyl ether
HBVE: 4-hydroxybutyl vinyl ether
HOVE: 8-hydroxyoctyl vinyl ether
DEGVE: diethylene glycol vinyl ether
HMcHVE: 4-(hydroxymethyl)cyclohexylmethyl vinyl ether
EVE: ethyl vinyl ether
cHVE: cyclohexyl vinyl ether
tBuVE: t-butyl vinyl ether
Vac: vinyl acetate

Concerning the constitutional components having a polysiloxane structure, the name of each component having a polysiloxane structure and the content (% by mass) of a structure derived from the polysiloxane structure-containing component in the whole polymer are indicated. Abbreviations have the following meanings.

FM-0721: “SILAPLANE FM-0721” (manufactured by Chisso Corporation)

### FM-0725: “SILAPLANE FM-0725” (do.)

VPS-1001: “Macroazo initiator VPS-1001” (manufactured by Wako Pure Chemical Industries
VPS-0501: “Macroazo initiator VPS-0501” (do.)

### (Synthesis of Hydroxyl Group-Containing Polymer)

The hydroxyl group-containing polymer to be used in the invention can be synthesized by various polymerization method, for example, solution polymerization, precipitation polymerization, block polymerization or emulsion polymerization. Also, it can be synthesized by using a well known procedure such as batchwise, semi-continuous or continuous polymerization.

To initiate the polymerization, use may be made of a method of using a radical initiator, a method of irradiating with light or radiation or the like. These polymerization methods and methods of initiating polymerization are reported by, for example, Teiji Tsuruta, Kobunshi Gosei Hoho, revised ed., (Nikkan Kogyo Shinbunsha, 1971) and Takayuki Otsu and Masayoshi Kinoshita, Kobunshi Gosei no Jikkenho, Kagakudojin, 1972, pages 124 to 154.

Among the polymerization methods as described above, the solution polymerization method with the use of a radical initiator is particularly preferred. As the solvent to be used in the solution polymerization method, use may be made of various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol ethanol, 1-propanol, 2-propanol and 1-butanol. Either one of these organic solvents or a mixture of two or more thereof may be used. Also, a mixture thereof with water may be used.

The polymerization temperature should be determined by taking the molecular weight of the target polymer, the type of the initiator employed and so on. Although the polymerization temperature may be from 0° C. or lower to 100° C. or higher, it is preferable to conduct the polymerization at a temperature of from 40 to 100° C.

The reaction pressure may be appropriately determined. In usual, it ranges from 0.01 to 10 MPa, preferably from 0.05 to 5 MPa and more preferably from about 0.1 to about 2 MPa. The reaction time ranges from about 5 to about 30 hours.

As the polymer thus obtained, the liquid reaction mixture may be used for the purpose of the invention. Alternatively, it may be purified by re-precipitation or liquid separation before using.

### <Cured Product and Laminate Film>

A cured product can be obtained by heating the curable composition of the invention. A cured film can be obtained by coating the curable composition of the invention to form a thin layer and then curing. The cured film thus obtained is useful as, for example, a protective layer for a base material. It is also possible to obtain a laminate film by coating the curable composition on a transparent support and curing the same to thereby form a layer. In particular, a curable composition containing the fluoropolymer as discussed above is useful as a composition for forming a low refractive index layer of an antireflective film. Next, an antireflective film in which the curable composition of the invention is particularly useful will be described.

### [Curable Composition to be Used in Forming Low Refractive Index Layer]

The low refractive index layer in the invention is formed by coating a curable composition which contains at least one hydroxyl group-containing polymer, at least one crosslinking agent having a fluorine atom and being reactive with hydroxyl group and at least one curing catalyst. As described above, it is preferable that the hydroxyl group-containing polymer is a polymer containing at least one fluorine-containing vinyl monomer polymerization unit (a) and at least one hydroxyl group-containing vinyl monomer polymerization unit (b). The individual components are as described above. If necessary, the curable composition may further contain a compound having a polysiloxane structure to thereby improve the stain proofness and the dust proofness.

### [Compound Having Polysiloxane Structure]

If necessary, the curable composition of the invention may further contain a compound having a polysiloxane structure to thereby improve the stain proofness and the dust proofness. Now, the compound having a polysiloxane structure will be illustrated.

In the invention, a compound having a polysiloxane structure may be used to impart slipperiness thereby further improving the scratch resistance and imparting stain proofness. The compound is not particularly restricted in structure. It is preferable to use a compound which contains several dimethylsilyloxy units as a repeating unit and has substituent(s) at an end and/or a side chain thereof. It may contain a structural unit other than the dimethylsilyloxy units in the chain having the dimethylsilyloxy units as the constitutional unit.

Although the molecular weight of the compound having a polysiloxane structure is not particularly restricted, it is preferably not more than 100,000, more preferably not more than 50,000 and preferably from 3,000 to 30,000.

From the viewpoint of preventing transfer, it is preferable that the compound having a polysiloxane structure contains a hydroxyl group a functional group which reacts with hydroxyl group to thereby form a bond. It is also preferable that this bond-forming reaction quickly proceeds under heating and/or in the presence of a catalyst. Examples of such substituent include an epoxy group, a carboxyl group and so on.

Preferable examples of the compound having a polysiloxane structure are as follows, though the invention is not restricted thereto.

### [Hydroxyl Group-Containing Compound]

“X-22-160AS”, “KF-6001”, “KF-6002”, “KF-6003”, “X-22-170DX”, “X-22-176DX”, “X-22-176D” and “X-22-176F” (each manufactured by SHIN-ETSU CHEMICAL Co.), “FM-4411”, “FM-4221”, “FM-4425”, “FM-0411”, “FM-0421”, “FM-0425”, “FM-DA11”, “FMDA21” and “FM-DA25” (each manufactured by Chisso Corporation), “CMS-626” and “CMS-222” (each manufactured by Gelest).

[Compound Having Functional Group Reactive with Hydroxyl Group]

“X-22-162C” and “KF-105” (each manufactured by SHIN-ETSU CHEMICAL Co.), “FM-5511”, “FM-5521”, “FM-5525”, “FM-6611”, “FM-6621” and “FM-6625” (each manufactured by Chisso Corporation).

It is preferable to add the compound having a polysiloxane structure as described above in an amount of from 0.01 to 20% by mass, more preferably from 0.05 to 15% by mass and more preferably from 0.1 to 10% by mass, based on the hydroxyl group-containing polymer.

### [Other Substances Contained in Curable Composition]

The curable composition of the invention contains the hydroxyl group-containing polymer (preferably a hydroxyl group-containing fluoropolymer), the crosslinking agent and the curing catalyst as described above optionally together with the compound having a polysiloxane structure. In addition to these components, it may further contain inorganic fine particles, an organosilane compound and other various additives. It can be prepared by dissolving these components in an appropriate solvent. In this step, the solid content of the curable composition may be appropriately selected depending on the purpose. In general, the solid content ranges from about 0.01 to about 60% by mass, preferably from about 0.5 to about 50% by mass and particularly preferably from about 1 to about 20% by mass.

### [Inorganic Fine Particles]

In the case of using the curable composition of the invention in forming a low refractive index layer of an antireflective film, the composition usually contains inorganic fine particles to, for example, improve the scratch resistance of the antireflective film. The content of the inorganic fine particles in the low refractive index layer preferably ranges from 1 to 100 mg/m², more preferably from 5 to 80 mg/m² and more preferably from 10 to 60 mg/m². When the content of the inorganic fine particles is not less than the lower limit as defined above, a remarkable effect of improving the scratch resistance can be achieved. When the content thereof is not more than the upper limit as defined above, it is possible to prevent troubles, for example, worsening in appearance such as definitiveness in black color and lowering integral reflection ratio due to the formation of fine peaks and valleys on the surface of the low refractive index layer. Thus, it is desirable to control the content of the inorganic fine particles within the above range.

It is preferable that the inorganic fine particles have a low refractive index, since they are to be added to the low refractive index layer. For example, use can be made of fine particles of magnesium fluoride or silica. From the viewpoints of refractive index, dispersion stability and cost, fine silica particles are particularly preferred.

The size of these inorganic fine particles preferably ranges from 1 to 200 nm, more preferably from 5 to 90 nm. When the particle size of the inorganic fine particles is not less than the lower limit as specified above, a remarkable effect of improving the scratch resistance can be obtained. When the particle size thereof is not more than the upper limit as specified above, it is possible to prevent troubles, for example, worsening in appearance such as definitiveness in black color and lowering integral reflection ratio due to the formation of fine peaks and valleys on the surface of the low refractive index layer. Thus, it is desirable to control the size of the inorganic fine particles within the above range.

The inorganic fine particles may have either crystalline or amorphous nature. Also, they may be either monodispersion particles or aggregates, so long as having such a particle size as defined above. Although spherical particles are preferred, irregularly shaped ones are also usable without any problem.

### [Organosilane Compound]

In the case of using the curable composition of the invention in forming a low refractive index layer, the composition may further contain an organosilane compound. The definition of the organosilane compound and structures of preferable compounds are the same as those mentioned in the paragraphs [0131] to [0132] in JP-A-2004-331812.

### [Other Additives]

In the case of using the curable composition of the invention in forming a low refractive index layer, the composition may further contain a small amount of a crosslinking agent other than those described above (for example, a polyfunctional (meth)acrylate compound or a polyfunctional epoxy compound) from the viewpoint of the interfacial adhesiveness of the low refractive index layer to the layer located immediately under the same. In the case of adding such a crosslinking agent, the content thereof is preferably not more than 30% by mass, more preferably not more than 20% by mass and particularly preferably not more than 10% by mass based on the total solid matters contained in the coating film of the low refractive index layer.

To impart favorable characteristics such as water resistance and chemical resistance and strengthen the stain proofness and the slipperiness, it is possible to add various publicly known stain proof agents, slipperiness improving agents (silicone-based compounds, fluorine compounds) and so on in addition to the compound having a polysiloxane structure as described above. In the case of using such an additive, the content thereof is from 0.01 to 20% by mass, more preferably from 0.05 to 10% by mass and particularly preferably from 0.1 to 5% by mass based on the total solid matters contained in the curable composition.

### (Fluorine Compound)

As the fluorine compound as described above, a compound having a fluoroalkyl group is preferred. It is preferable that the fluoroalkyl group has from 1 to 20 carbon atoms, more preferably from 1 to 10 carbon atoms. It may have either a linear structure {for example, —CF₂CF₃, —CH₂(CF₂)₄H, —CH₂ (CF₂)₈CF₃, —CH₂CH₂(CF₂)₄ and so on}, a branched structure {for example, —CH(CF₃)₂, —CH₂CF(CF₃)₂, —CH(CH₃)CF₂CF₃, —CH(CH₃)(CF₂)₅CF₂H and so on}, or an alicyclic structure (preferably a 5-membered or 6-membered ring such as a perfluorocyclohexyl group, a perfluorocyclopentyl group or an alkyl group substituted by such a group and so on). Moreover, it may have an ether bond (for example, —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H and so on). Two or more fluoroalkyl groups may be contained in a single molecule.

It is preferable that the fluorine compound further has a substituent which contributes to the formation of a bond with the coating film of the low refractive index layer or the compatibility therewith. It may have either the same or different substituents and two or more substituents are preferred. Preferable examples of the substituent include an acryloyl group, a methacryloyl group, a vinyl group, an aryl group, a cinnamoyl group, an epoxy group, an oxetanyl group, a hydroxyl group, a polyoxyalkylene group, a cabroxyl group, an amino group and so on. The fluorine compound may be a polymer or an oligomer with a fluorine-free compound and the molecular weight thereof is not particularly restricted.

Although the fluorine content in the fluorine compound is not particularly restricted, it is preferably 20% by mass or above, more preferably from 30 to 70% by mass and most preferably from 40 to 70% by mass.

Preferable examples of the fluorine compound include “R-2020”, “M-2020”, “R-3833” and “M-3833” (trade names, each manufactured by DAIKIN INDUSTRIES, Ltd.), “MEGAFAC F-171”, “MEGAFAC F-172”, “MEGAFAC F-179A” and “DEFENSA MCF-300” (trade names, each manufactured by DAINIPPON INK & CHEMICALS, Co.) and so on, though the invention is not restricted thereto.

### (Dust Proof Agent, Antistatic Agent and so on)

To impart favorable characteristics such as dust proofness and antistatic properties, the curable composition for forming a low refractive index layer may optionally contain a publicly known dust proof agent such as a cationic surfactant or a polyoxyalkylene compound, an antistatic agent and so on. The structural units of such dust proof agent and antistatic agent may be contained as one of the functions thereof in the silicone-based compound or the fluorine compound as described above.

In the case of using these additives, the content thereof is preferably from 0.01 to 20% by mass, more preferably from 0.05 to 10% by mass and particularly preferably from 0.1 to 5% thereof based on the total solid matters in the curable composition.

Preferable examples of these compounds include “MEGAFAC F-150” (trade name, manufactured by DAINIPPON INK & CHEMICALS, Co.) and “SH-3748” (trade name, manufactured by DOW CORNING TORAY) and so on, though the invention is not restricted thereto.

### [Solvent]

As the solvent to be used in a coating solution (the curable composition) for forming a low refractive index layer in the invention, use can be made of various solvents selected by considering the individual components being soluble or dispersible therein, easily giving an even face in the coating and drying steps, ensuring storage in the form of a liquid, having an adequate saturation vapor pressure and so on. From the viewpoint of drying load, it is preferable to use a solvent comprising a solvent having a boiling point of 100° C. or lower at room temperature under atmospheric pressure as the main component together with a small amount of another solvent having a boiling point of 100° C. or higher so as to control the drying speed.

Examples of the solvent having a boiling point of 100° C. or lower include hydrocarbons such as hexane (boiling point: 68.7° C.), heptane (98.4° C.), cyclohexane (80.7° C.) and benzene (80.1° C.),); halogenated hydrocarbons such as dichloromethane (39.8° C.), chloroform (61.2° C.), carbon tetrachloride (76.8° C.), 1,2-dichloroethane (83.5° C.) and trichloroethylene (87.2° C.); ethers such as diethyl ether (34.6° C.), diisopropyl ether (68.5° C.), dipropyl ether (90.5° C.) and tetrahydrofuran (66° C.); esters such as ethyl formate (54.2° C.), methyl acetate (57.8° C.), ethyl acetate (77.1° C.) and isopropyl acetate (89° C.); ketones such as acetone (56.1° C.) and 2-butanone (the same as methyl ethyl ketone; 79.6° C.); alcohols such as methanol (64.5° C.), ethanol (78.3° C.), 2-propanol (82.4° C.) and 1-propanol (97.2° C.); cyano compounds such as acetonitrile (81.6° C.) and propionitrile (97.4° C.); carbon disulfide (46.2° C.), and so on. Among all, ketones and esters are preferred and ketones are particularly preferred. Among ketones, 2-butanone is particularly preferable.

Examples of the solvent having a boiling point of 100° C. or higher include octane (125.7° C.), toluene (110.6° C.), xylene (138° C.), tetrachloroethylene (121.2° C.), chlorobenzene (13.17° C.), dioxane (101.3° C.), dibutyl ether (142.4° C.), isobutyl acetate (118° C.), cyclohexanone (155.7° C.), 2-methyl-4-pentanone (the same as methyl isobutyl ketone (MIBK); 115.9° C.), 1-butanol (117.7° C.), N,N-dimethylformamide (153° C.), N,N-dimethylacetamide (166° C.), dimethyl sulfoxide (189° C.) and so on. Cyclohexanone and 2-methyl-4-pentanone are preferred.

### [Method of Forming Low Refractive Index Layer]

The low refractive index layer of the antireflective film according to the invention can be formed by the following coating method, though the invention is not restricted thereto.

### [Coating System]

First, a curable composition (coating solution) for forming the low refractive index layer is prepared. The obtained coating solution is coated on a transparent support with the use of, for example, dip coating method, air knife coating method, curtain coating method, roller coating method, wire bar coating method, gravure coating method or extrusion coating method (see U.S. Pat. No. 2,681,294) followed by heating and drying.

Among these coating methods, the gravure coating method is favorable since a coating solution in a small coating amount (for example, one for forming the low refractive index layer of an antireflective film) can be applied to give a uniform membrane thickness thereby. In the gravure coating method, microgravure method, whereby a high membrane thickness uniformity can be established, is particularly preferable.

### (Microgravure Coating Method)

The microgravure coating method to be used in the invention is a coating method comprising rotating a gravure roll, which has a diameter of from about 10 to about 100 mm (preferably from about 20 to about 50 mm) and has a gravure pattern printed all over the periphery thereof in the lower part of the substrate in the direction opposite to the traveling direction of the support, stripping off the excessive coating solution by a doctor blade from the surface of the gravure roll and thus transferring an almost definite amount of the coating solution to the lower face of the support at a position where the upper face of the support is in the free state, thereby conducting coating. The transparent support in a rolled form is continuously unwound. Thus, the low refractive index layer can be coated in one side of the thus unwound support by the microgravure method.

Concerning the coating conditions by the microgravure method, it is preferable that a gravure pattern has a line density of from 50 to 800 lines/in. and more preferably from 100 to 300 lines/in. The depth of the gravure pattern is preferably from 1 to 600 μm and more preferably from 5 to 200 μm. The rotational speed of the gravure roll is preferably from 3 to 800 rpm and more preferably from 5 to 200 rpm. The traveling speed of the support is preferably from 0.5 to 100 m/min and more preferably from 1 to 50 m/min.

To supply the antireflective film of the invention at a high productivity, use is preferably made of the extrusion method (die coating method). Since a premeasurement step is employed in this die coating method, the film thickness can be relatively easily controlled and little solvent evaporates in the coated part, which makes the method favorable.

### [Method of Curing Coating Film]

After drying the solvent, the antireflective film of the invention, which is in the state of a web consisting of the transparent support and the coating films formed thereon, is passed through a zone for curing each coating film by ionizing radiation and/or heating so that the coating films can be cured. Curing can be conducted by conducting either heating or ionizing radiation alone. Alternatively, it is also preferable to perform these procedures successively. Namely, selection can be appropriately made depending on the materials employed.

Conditions for the heat curing are not particularly restricted, so long as a binder can undergo the crosslinking reaction. It is preferable to conduct the heat curing at a temperature of from 40 to 200° C., more preferably from 60 to 130° C. and most preferably from 80 to 120° C. The heat curing time ranges from 30 sec to 24 h, preferably from 60 sec to 1 h and most preferably from 3 min to 20 min, though it varies depending on the composition of the curing components and the type, amount of the catalyst and so on.

The film face temperature may be controlled to a desired level by an arbitrary method without specific restriction. Use is preferably made of, for example, a method of contacting the film with a heated roll, a method of blowing heated nitrogen gas thereto or a method of irradiating with far infrared light or near infrared light. Use can be also made of a method wherein heating is conducted by passing hot water or steam in a rotational metal roll, as described in Japanese Patent No. 2523574. In the case where the film face temperature is elevated in the step of irradiating with the ionizing radiation as will be described hereinafter, on the contrary, use can be made of a method of contacting the film with a cooled roll.

The ionizing radiation species to be used in the invention is not particularly restricted but appropriately selected from among ultraviolet rays, electron beams, near ultraviolet light, visual light, near infrared light, infrared light, X-ray and so on depending on the type of the curable composition forming a coating film. Among all, ultraviolet light and electron beams are preferable. In particular, ultraviolet light is preferable because of being convenient in handling and easily giving high energy.

As the light source of the ultraviolet light, any light source capable of generating ultraviolet light is usable. For example, use can be made of a low-pressure mercury lamp, a medium-pressure mercury lamp, a high-pressure mercury lamp, an ultrahigh pressure mercury lamp, a carbon arc lamp, a metal halide lamp, a xenon lamp and so on. Also, use can be made of an ArF excimer laser beam, a KrF excimer laser beam, an excimer lamp or synchrotron radiation. Among these light sources, it is preferable to employ an ultrahigh pressure mercury lamp, a high-pressure mercury lamp, a low-pressure mercury lamp, a carbon arc lamp, a xenon arc lamp or a metal halide lamp.

It is also possible to use an electron beam. Examples of the electron beam include electron beams emitted from various electron beam accelerators of, for example, the Cockroft-Walton type, the Vandergraph type, the resonance transformation type, the insulated core transformer type, the linear type, the dynamitron type or the high-frequency type and having an energy of from 50 to 1000 keV, preferably from 100 to 300 keV.

Although the irradiation conditions vary from lamp to lamp, the irradiation dose is preferably 10 mJ/cm² or more, more preferably from 50 mJ/cm² to 10000 mJ/cm² and particularly preferably from 50 mJ/cm² to 2000 mJ/cm². In this step, the irradiation dose distribution in the width direction including both edges of the web preferably ranges from 50 to 100%, more preferably from 80 to 100%, based on the maximum irradiation dose at the center.

In the invention, it is preferable that at least one layer laminated on a support is cured by the step of irradiating with an ionizing radiation in which the ionizing radiation is irradiated under heating to give a film face temperature of 60° C. or higher for 0.5 sec or longer from the initiation of the irradiation with the ionizing radiation in an atmosphere with an oxygen concentration of 10% by volume or less.

Also, it is preferable to heat the layer in an atmosphere with an oxygen concentration of 3% by volume or less simultaneously with the irradiation with the ionizing radiation and/or continuously thereafter. In particular, it is preferable to cure a low refractive index layer, which is provided as the outermost layer and has a small thickness, by this method. Thus, the curing reaction is accelerated by heating to give a film excellent in mechanical strength and chemical resistance.

It is preferable that the irradiation with the ionizing radiation is conducted for 0.5 sec or longer but not longer than 60 sec and more preferably 0.7 sec or longer but not longer than 10 sec. By irradiating for 0.5 sec or longer, the curing reaction can proceed to a certain extent and sufficient curing can be established. It is favorable to complete the irradiation within 10 sec at the longest. This is because a large-scaled equipment and a large amount of an inert gas are needed to maintain the low-oxygen conditions over a long period of time.

It is preferable to conduct the crosslinking reaction or the polymerization of the curable composition in an atmosphere with an oxygen concentration of 6% by volume or less, more preferably with an oxygen concentration of 4% by volume or less, particularly preferably with an oxygen concentration of 2% by volume or less and most preferably with an oxygen concentration of 1% by volume or less. To unnecessarily lower the oxygen concentration, an inert gas such as nitrogen should be used in a large amount. From the viewpoint of production cost, therefore, it is preferable that the oxygen concentration is 6% by volume or less.

It is also preferable that the layer under the low refractive index layer is incompletely cured (i.e., regulating the curing rate of the layer (100−the content of residual functional group) to a certain level lower than 100%) and the low refractive index layer formed thereon is cured by ionizing radiation and/or heat. This is because the curing rate of the under layer is elevated thereby compared with the rate before the formation of the low refractive index layer and the adhesiveness between the under layer and the low refractive index layer is improved.

### <Antireflective Film>

The antireflective film of the invention has a low refractive index layer, which is formed by coating the curable composition of the invention as described above, on a transparent support.

### [Fundamental Constitution of Antireflective Film]

The antireflective film of the invention comprises a low refractive index that is an essentially required optical layer, optionally together with a hard coat layer as will be described hereinafter as well as layer(s) laminated thereon taking refractive index, film thickness, number of layers, lamination order, etc. into consideration.

In the simplest constitution, the antireflective film with a low reflectivity of the invention merely consists of a base material and a low refractive index formed thereon. To further lower the reflectivity, it is preferable to form an antireflective layer comprising a combination of a high refractive index layer having a refractive index higher than the refractive index of the base material with a low refractive index layer having a refractive index lower than the refractive index of the base material. Examples of the constitution thereof include a double-layered laminate having a high refractive index layer/a low refractive index layer from the base material side and a triple-layered laminate having an medium refractive index layer (having a refractive index higher than the refractive index of the base material or the hard coat layer but lower than the refractive index of the high refractive index layer)/a high refractive index layer/a low refractive index layer in this order from the base material side. Furthermore, there have been proposed antireflective films having a larger number of antireflective layers laminated.

Next, preferable examples of the layer constitution of the antireflective film of the invention will be shown. In the following constitutions, a base film serves as a support.
Base film/low refractive index layer
Base film/antistatic layer/low refractive index layer
Base film/antiglare layer/low refractive index layer
Base film/antiglare layer/antistatic layer/low refractive index layer
Base film/antistatic layer/antiglare layer/low refractive index layer
Base film/hard coat layer/antiglare layer/low refractive index layer
Base film/hard coat layer/antiglare layer/antistatic layer/low refractive index layer
Base film/hard coat layer/antistatic layer/antiglare layer/tow refractive index layer
Base film/hard coat layer/high refractive index layer/low refractive index layer
Base film/hard coat layer/antistatic layer/high refractive index layer/low refractive index layer
Base film/hard coat layer/medium refractive index layer/high refractive index layer/low refractive index layer
Base film/antiglare layer/high refractive index layer/low refractive index layer
Base film/antiglare layer/medium refractive index layer/high refractive index layer/low refractive index layer
Base film/antistatic layer/hard coat layer/medium refractive index layer/high refractive index layer/low refractive index layer
Antistatic layer/base film/hard coat layer/medium refractive index layer/high refractive index layer/low refractive index layer
Base film/antistatic layer/antiglare layer/medium refractive index layer/high refractive index layer/low refractive index layer
Antistatic layer/base film/antiglare layer/medium refractive index layer/high refractive index layer/low refractive index layer
Antistatic layer/base film/antiglare layer/high refractive index layer/low refractive index layer/high refractive index layer/low refractive index layer

The invention is not restricted to these layer constitutions, so long as the reflectivity can be lowered by optical interference. The high refractive index layer may be a light diffusion layer having no antiglare properties. The antistatic layer is preferably a layer containing a conductive polymer particles or fine metal oxide particles (for example, ATO or ITO). It can be formed by coating, atmospheric plasma treatment or the like.

Next, the fundamental constitution of an appropriate antireflective film will be described by referring drawings as an embodiment of the invention.

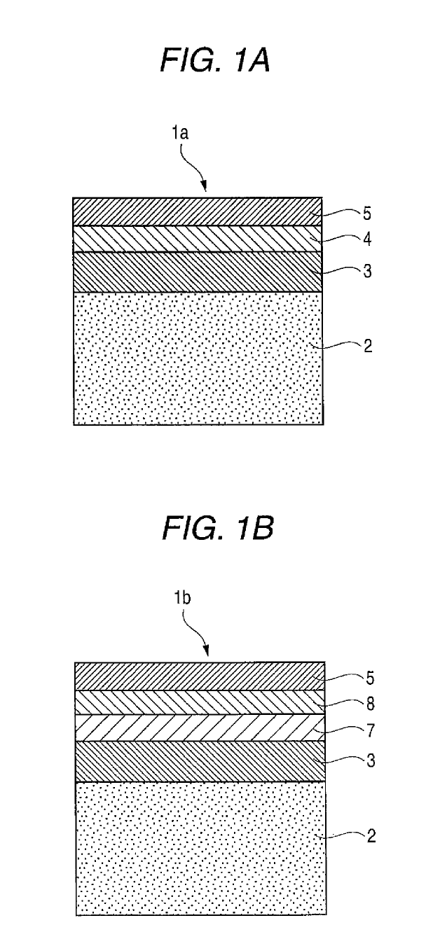

The schematic sectional view shown in FIG. 1A is an exemplary example of the antireflective film according to the invention. The antireflective film 1a has a layer constitution consisting of a transparent support 2, a hard coat layer 3, an antiglare hard coat layer 4 and a low refractive index layer 5 in this order.

In the antiglare hard coat layer 4, matting particles (not shown in the figure) are dispersed. It is preferable that the refractive index of the material of the antiglare hard coat layer 4 other than the matting particle ranges from 1.48 to 2.00 and more preferably from 1.50 to 1.80. It is preferable that the refractive index of the low refractive index layer ranges from 1.20 to 1.47 and more preferably from 1.30 to 1.44.

In the invention, the hard coat layer may be either an antiglare hard coat layer as in this case or a hard coat layer having no antiglare properties. Also, it may consist of either a single layer or multiple layers, for example, two to four layers. It is also possible to employ no hard coat layer. Accordingly, the hard coat layer 3 and the antiglare hard coat layer 4 shown in FIG. 1A are not always required. To impart appropriate film strength, however, it is preferable to form any of these hard coat layers. The low refractive index is provided as the outermost layer.

The schematic sectional view shown in FIG. 1B is another example of the antireflective film according to the invention. The antireflective film 1b has a layer constitution consisting of a transparent support 2, a hard coat layer 3, a medium refractive index layer 7, a high refractive index layer 8 and a low refractive index layer 5 (the outermost layer) in this order. The transparent support 2, the medium refractive index layer 7, the high refractive index layer 8 and the low refractive index layer 5 have respectively refractive indexes satisfying the following requirements.

Refractive index of high refractive index layer>refractive index of medium refractive index layer>refractive index of transparent support>refractive index of low refractive index layer

In the layer constitution as shown in FIG. 1B, it is preferable from the viewpoint of forming an antireflective film having better antireflective performance that the medium refractive index layer, the high refractive index layer and the low refractive index layer satisfy respectively the requirements represented by the following numerical formulae (1), (2) and (3) as described in JP-A-59-50401.

(hλ/4)×0.7<n1d1<(hλ/4)×1.3 Numerical formula (1)

(iλ/4)×0.7<n2d2<(iλ/4)×1.3 Numerical formula (2)

(jλ/4)×0.7<n3d3<(jλ/4)×1.3 Numerical formula (3)

In the numerical formulae (1) to (3), h represents a positive integer (generally being 1, 2 or 3); i represents a positive integer (generally being 1, 2 or 3); and j represents a positive odd number (generally being 1). n1, n2 and n3 respectively represent the refractive indexes of the medium refractive index layer, the high refractive index layer and the low refractive index layer. d1, d2 and d3 respectively represent the layer thicknesses (nm) of the medium refractive index layer, the high refractive index layer and the low refractive index layer. λ means a setting wavelength the refractive index at which is to be lowered. In the case of using the antireflective film in a commonly employed display surface, λ represents the wavelength (nm) of visible light and thus falls within the range of from 380 to 680 nm. By setting λ within a range with a high human visibility, i.e., from 500 to 550 nm, an antireflective film having a low visible reflectivity can be obtained.

In the layer constitution as shown in FIG. 1B, it is particularly preferable that the medium refractive index layer, the high refractive index layer and the low refractive index layer satisfy respectively the requirements represented by the following numerical formulae (1-1), (2-1) and (3-1), wherein λ is 500 nm, h is 1, i is 2 and j is 1.

(hλ/4)×0.80<n1d1<(hλ/4)×1.00 Numerical formula (1-1)

(iλ/4)×0.75<n2d2<(iλ/4)×0.95 Numerical formula (2-1)

(jλ/4)×0.95<n3d3<(jλ/4)×1.05 Numerical formula (3-1)

The terms “high refractive index”, “medium refractive index” and “low refractive index” as used herein are indicated in the relative refractive index level among the layers. In FIG. 1B, the high refractive index layer is employed as an optical interference layer and thus an antireflective film having highly favorable antireflective performance can be constructed.

### [Low Refractive Index Layer]

Next, the low refractive index layer in the antireflective film of the invention will be described.

The refractive index of the low refractive index layer according to the invention preferably ranges from 1.20 to 1.47 and more preferably from 1.30 to 1.44. The thickness of the low refractive index layer is preferably 50 nm or more but not more than 400 nm, more preferably 60 nm or more but not more than 150 nm and most preferably 60 nm or more but not more than 130 nm.

Moreover, it is preferable from the viewpoint of lowering the refractive index that the low refractive index layer satisfies the following numerical formula (3).

(jλ/4)×0.7<n3d3<(jλ/4)×1.3 Numerical formula (3)

In the numerical formula (3), j is a positive odd number and n3 and d3 represent respectively the refractive index and the film thickness (nm) of the low refractive index layer as stated above. λ means a setting wavelength the refractive index at which is to be lowered. By setting λ within a range with a high human visibility, i.e., from 500 to 550 nm, an antireflective film having a low visible reflectivity can be obtained.

Satisfying the above numerical formula (3) indicates that there is j (being a positive odd number and generally 1) satisfying the numerical formula (3) within the wavelength range as defined above.

[Layers Other than Low Refractive Index Layer]

### [Film-Forming Binder]

As the main film-forming binder component in the film-forming composition constituting the layers other than the low refractive index layer in the invention, it is preferable to use a compound having an ethylenically unsaturated bond form the viewpoints of film strength, stability of coating solution, film productivity and so on. The term “main film-forming binder” means a component amounting to 10% by mass or more, preferably 20% by mass or more but not more than 10% by mass and more preferably 30% by mass or more but not more than 95% by mass, in the film-forming components excluding organic particles.

As the binder, it is preferable to use a polymer having a saturated hydrocarbon chain or a polyether chain as the main chain and a polymer having a saturated hydrocarbon chain is still preferable. As the binder polymer having a saturated hydrocarbon chain as the main chain and a crosslinked structure, a (co)polymer of monomer(s) having two or more ethylenically unsaturated bonds is preferable.

### (Polymer Having Saturated Hydrocarbon Chain as the Main Chain)

Examples of the monomer having two or more ethylenically unsaturated bonds include esters of polyhydric alcohol with (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate and so on), divinyl benzene and its derivatives (for example, 1,4-divinyl benzene, 4-vinylbenzoic acid-2-acryloylethyl ester, 1,4-divinyl cyclohexanone and so on), vinyl sulfones (for example, divinyl sulfone), acrylamides (for example, methylenebisacrylamide) and methacrylamides. Two or more of these monomers may be used together.

The term “(meth)acrylate” as used herein means “acrylate or methacrylate”.

To elevate the refractive index of the coating film thus formed, it is preferable that the monomer structure contains an aromatic cyclic group or at least one atom selected from among halogen atoms other than fluorine atom, a sulfur atom, a phosphorus atom and a nitrogen atom.

Specific examples of the monomer having high refractive index include bis(4-methacryloylthiophenyl) sulfide, vinyl naphthalene, vinyl phenyl sulfide, 4-methacryloyloxyphenyl-4′-methoxyphenyl thioether and so on. Two or more of these monomers may be used together.

### (Polymerization Initiator)

Such monomers having an ethylenically unsaturated bond can be polymerized by irradiating with ionizing radiation or heating in the presence of a photo radical polymerization initiator or a heat polymerization initiator.

### (Photo Radical Polymerization Initiator)

As the photo radical polymerization initiator, use can be made of acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfonium compounds.

Examples of the acetophenones include 2,2-diethoxyacetophenone, p-dimethylacetophenone, 1-hydroxydimetmhyl phenyl ketone, 1-hydroxycyclohexyl phenyl ketone, 2-methyl-4-methylthio-2-morpholinopropiophenone and 2-benzyl-2-dimethylamino-1-(4-morpholinophenyl)-butanone.

Examples of the benzoins include benzoin benzenesulfonate, benzoin toluenesulfonate, benzoin methyl ether, benzoin ethyl ether and benzoin isopropyl ether.

Examples of the benzophenones include benzophenone, 2,4-dichlorobenzophenone, 4,4-dichlorobenzophenone and p-chlorobenzophenone. Examples of the phosphine oxides include 2,4,6-trimethylbenzoyldiphenylphosphine oxide.

Moreover, various examples of photo radical polymerization initiator are presented in Saishin UV Koka Gijutsu, (p. 159, publisher: Kazuhiro Takausu, publishing office: GIJUTSU KYOKAI K.K.) and these initiators are useful in the invention.

As preferable examples of commercially available photo radical polymerization initiators of photo cleavage type, “IRGACURES (651, 184, 907)” (manufactured by Ciba-Geigy) may be cited.

The photo radical polymerization initiator is used preferably in an amount of from 0.1 to 15 parts by mass and more preferably from 1 to 10 parts by mass, per 100 parts by mass of the total amount of the polyfunctional monomers as described above.

In addition to the photo radical polymerization initiator, it is also possible to use a photo sensitizer. Specific examples of the photo sensitizer include n-butylamine, triethylamine, tri-n-butylphosphine, Micheler's ketone and thioxanthone.

### (Heat Radical Polymerization Initiator)

As the heat radical polymerization initiator, use can be made of, for example, an organic or inorganic peroxide, an organic azo or diazo-compound. More specifically speaking, examples of the organic peroxide include benzoyl peroxide, halogenobenzoyl peroxides, lauroyl peroxide, acetyl peroxide, dibutyl peroxide, cumene hydroxyperoxide and butyl hydroxyperoxide; examples of the inorganic peroxide include hydrogen peroxide, ammonium persulfate and potassium persulfate; examples of the azo compound include 2-azobisisobutyronitrile, 2-azobispropionitrile and 2-azobiscyclohexanedinitrile; and examples of the diazo compound include diazoaminobenzene and p-nitrobenzene diazonium.

### (Polymer Having Polyether as the Main Chain)

In the invention, use can be also made of a polymer having polyether as the main chain. It is preferable to employ a ring-opening polymer of a polyfunctional epoxy compound. The ring-opening polymerization of the polyfunctional epoxy compound can be carried out by ionizing radiation or heating in the presence of a photo acid producing agent or a heat acid producing agent.

It is also possible to use a monomer having a crosslinking functional group, as a substitute for the monomer having two or more ethylenically unsaturated bonds or in addition thereto, to thereby introduce the crosslinking functional group into the polymer. Thus, a crosslinked structure can be introduced into the binder polymer owing to the reaction of this crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. As a monomer for introducing a crosslinked structure, use can be also made of vinylsulfonic acid, an acid anhydride, a cyanoacrylate derivative, melamine, etherified methylol, an ester and urethane and a metal alkoxide such as tetramethoxysilane. It is also possible to use a functional group that shows crosslinking ability as the result of a decomposition reaction, for example, a blocked isocyanate group. Namely, the crosslinking functional group to be used in the invention may be either one showing an immediate reactivity or one showing a reactivity after decomposition.

The binder polymer having such a crosslinking functional group can form a crosslinked structure by heating after the coating

### [Hard Coat Layer]

It is preferable that the antireflective film of the invention is provided with a hard coat layer. In the hard coat layer, matting particles for imparting antiglare properties may be added to the binder so that the hard coat layer also serves as an antiglare layer. To elevate refractive index, prevent shrinkage caused by the crosslinking and enhance the strength, it is also possible to add an inorganic filler thereto so that the hard coat layer also serves as a high refractive index layer. Moreover, the hard coat layer may be formed by adding such an organosilane compound as described with respect to the low refractive index layer.

### (Matting Particles)

To impart antiglare properties, the hard coat layer contains, if necessary, matting particles being larger than filler particles and having an average particle size of from 0.1 to 5.0 μm, preferably from 1.5 to 3.5 μm, such as particles of an inorganic compound or resin particles.

When the difference in refractive index between the matting particles and the binder is too large, the resultant film becomes cloudy. When the difference is too small, no sufficient light scattering effect can be established. Thus, the difference preferably ranges from 0.02 to 0.20 and particularly preferably from 0.040 to 0.10. When the matting particles are added at a too large ratio to the binder, the resultant film becomes cloudy similar to the case of refractive index. When the ratio thereof is too small, no sufficient light scattering effect can be established. Thus, the amount thereof is preferably from 3 to 30% by mass and particularly preferably from 5 to 20% by mass.

Specific examples of the matting particles include particles of inorganic compounds such as silica particles and TiO₂ particles; and resin particles such as acryl particles, crosslinked acryl particles, crosslinked polystyrene particles, crosslinked styrene particles, melamine resin particles and benzoguanamine resin particles. Among all, crosslinked styrene particles, crosslinked acryl particles and silica particles are preferred.

These matting particles may be either spherical or irregular-shaped.

Also, use can be made of two or more types of different matting particles.

To effectively control refractive index by mixing two or more types of matting particles in the case of using the same, it is preferable that the difference in refractive index between these matting particles is 0.02 or larger but not larger than 0.01 and more preferably 0.03 or larger but nor larger than 0.07. It is also possible to impart antiglare properties by matting particles having a larger particle size and other optical characteristics by matting particles having a smaller particle size. In the case of bonding an antireflective film to a high-definition display of 133 ppi or more, for example, a trouble in the optical performance called “glare” should be avoided. Glare arises when pixels are enlarged or shrunk and brightness becomes uneven due to small peaks and valleys on the film surface (contributing to the antiglare properties). This problem can be considerably solved by using matting particles imparting to the antiglare properties together with matting particles which have a smaller particle size than the former and a refractive index different from the refractive index of the binder.

Concerning the particle size distribution of the matting particles as described above, monodispersion is most desirable. That is to say, it is preferred that the sizes of individual particles are as close as possible. In the case where particles having particle size larger by 20% or more than the average particle size are specified as coarse particles, for example, it is preferable that the content of these coarse particles is 1% or less of all particles, more preferably 0.1% or less and more preferably 0.01% or less. Matting particles having such a particle size distribution can be obtained by classifying particles after the completion of a usual synthesis reaction. Matting particles having a still preferable distribution can be obtained by performing the classification in an increased number or at an elevated level.

These matting particles are added to the hard coat layer so that the content of the matting particles in the hard coat layer amounts preferably to 10 to 1000 mg/m² and more preferably 100 to 700 mg/m².

The particle size distribution of the matting particles is measured by the Coulter counter method and the distribution thus measured is converted into the particle number distribution.

### (Inorganic Filler)

To elevate the refractive index of the layer and reduce contraction due to hardening, the hard coat layer preferably contains, in addition to the matting particles as described above, an inorganic filler which comprises oxide of at least one metal selected from among titanium, zirconium, aluminum, indium, zinc, tin and antimony and has an average particle size of 0.2 μm or less, preferably 0.1 μm or less and more preferably 0.06 μm or less.

To enlarge the difference in refractive index between the hard coat layer and the matting particles, it is also possible in a hard coat layer with the use of matting particles having a high refractive index to employ silicon oxide to thereby maintain the refractive index of the layer at a low level. The preferable particle size thereof is the same as the inorganic filler as described above.

Specific examples of the inorganic filler to be used in the hard coat layer include TiO₂, ZrO₂, Al₂O₃, In₂O₃, ZnO, SnO₂, Sb₂O₃, ITO, SiO₂ and so on. TiO₂ and ZrO₂ are preferred from the viewpoint of elevating refractive index.

It is also preferable that the inorganic filler is surface-treated by silane coupling or titanium coupling. Use is preferably made of a surface-treating agent having a functional group capable of reacting with the binder on the filler surface.

The content of such an inorganic filler is preferably from 10 to 90% based on the total mass of the hard coat layer, more preferably from 20 to 80% and particularly preferably from 30 to 70%.

Because of having a particle size sufficiently smaller than the light wavelength, the inorganic filler causes no scattering. Therefore, a dispersion having the filler dispersed throughout the binder polymer behaves as an optically homogeneous substance.

The bulk refractive index of the mixture of the binder with the inorganic filler in the hard coat layer is preferably from 1.48 to 2.00 and more preferably from 1.50 to 1.80. The refractive index can be controlled within the range as specified above by appropriately selecting the types and mixing ratio of the binder and the inorganic filler. It can be easily understood through preliminary experiments how to select these materials.

The antireflective film according to the invention thus formed has a haze of preferably from 3 to 70% and more preferably from 4 to 60%, an average reflectivity at 450 nm to 650 nm of preferably 3.0% or less and more preferably 2.5% or less. So long as the antireflective film according to the invention has a haze and an average reflectivity respectively falling within the above ranges) favorable antiglare properties and antireflective properties can be established without worsening transfer imaging.

### [Support]

As the transparent support in the antireflective film according to the invention, it is preferable to employ a plastic film. Examples of the polymer constituting the plastic film include cellulose esters {for example, triacetylcellulose and diacetyl cellulose typified by “FUJITAC TD80U” and “FUJITAC TD80UF”, manufactured by FUJI PHOTOFILM Co., Ltd. (now, FUJIFILM Corporation)), polyamides, polycarboantes, polyesters (for example, polyethylene terephthalate and polyethylene naphthalate), polystyrenes, polyolefins, norbornene resins (for example, “ARTON™” manufactured by JSR) and amorphous polyolefins (for example, “ZEONEX™” manufactured by ZEON)}. Among these materials, triacetyl cellulose, polyethylene terephthalate and polyethylene naphthalate are preferable and triacetylcellulose is particularly preferable.

A cellulose acrylate film substantially free from any halogenated hydrocarbons such as dichloromethane and a method of producing the same are described in Japan Institute of Invention and Innovation Journal of Technical Disclosure No. 2001-1745 (2001 Mar. 15) hereinafter abbreviated as Journal of Technical Disclosure No. 2001-1745). The cellulose acrylate described therein can be preferably used in the present invention.

### [Saponification]

In the case where the antireflective film according to the invention is employed in an image display device, a pressure-sensitive layer or the like is formed on one face thereof and the antireflective film is provided as the outermost face of the display. When the transparent support of the antireflective film is made of triacetyl cellulose, it is favorable from the viewpoint of cost to use the antireflective film of the invention as a protective film as such, since triacetyl cellulose is used as a protective film protecting a polarizing film of a polarizing plate.

In the case where the antireflective film according to the invention, which has a pressure-sensitive layer or the like on one face, is provided as the outermost face of an image display device or as a protective film for a polarizing plate as such, it is preferable to form an outermost layer mainly comprising a fluoropolymer on the transparent support followed by saponification, thereby ensuring sufficient adhesion.

The saponification can be carried out by a publicly known procedure, for example, dipping the film in an alkali solution for an appropriate time. After dipping in the alkali solution, it is preferable to sufficiently wash the film with water or neutralize the alkali component by dipping in a dilute acid, thereby eliminating the alkali component remaining in the film. Owing to the saponification, the surface of the transparent support opposite to the side having the outermost layer becomes hydrophilic.

The hydrophilic surface of the transparent support of the antireflective film is particularly effective in improving the adhesiveness to a polarizing film comprising polyvinyl alcohol as the main component. Since dust and debris in the atmosphere hardly stick to the hydrophilic surface, moreover, dust and debris scarcely enter into the space between the polarizing film and the antireflective film in the step of adhering to the polarizing film) which brings about another advantage of preventing defect spots caused by dust and debris.

It is preferable to perform the saponification treatment so that the contact angle of the transparent support surface opposite to the side having the outermost layer to water becomes 40° or smaller, more preferably 30° or smaller and particularly preferably 20° or smaller.

In practice, the alkali saponification can be carried out by a procedure selected from the following means (1) and (2). Between them, the means (1) is favorable from the viewpoint that the treatment can be carried out in the same step as the cellulose acrylate film formation commonly employed. However, the means (1) suffers from some problems such that the antireflective layer surface is also saponified and thus the film is deteriorated due to alkali-hydrolysis and that the remaining saponification solution would cause stains. In contrast, the means (2) is favorable, though an additional step is required.

(1) After forming an antireflective layer on a transparent support, the film is dipped at least once in an alkali solution to thereby saponify the back face of the antireflective film.

(2) Before or after forming an antireflective layer on a transparent support, an alkali solution is coated on the face of the transparent support opposite to the face on which the antireflective layer is to be formed. Then the transparent support is heated, washed with water and/or neutralized to thereby saponify the back face alone of the film.

### [Film-Forming Method]

The antireflective film of the invention can be formed by the following methods, though the invention is not restricted thereto.

### [Coating System]

First, a curable composition (coating solution) for forming each layer is prepared. The obtained coating solution is coated on a transparent support with the use of, for example, dip coating method, air knife coating method, curtain coating method, roller coating method, wire bar coating method, gravure coating method or extrusion coating method (see U.S. Pat. No. 2,681,294) followed by heating and drying.

Among these coating methods, the gravure coating method is favorable since a coating solution in a small coating amount (for example, one for forming each layer of an antireflective film) can be applied to give a uniform membrane thickness thereby. In the gravure coating method, microgravure method, whereby a high membrane thickness uniformity can be established, is particularly preferable.

By using the die coating method, a small amount of a coating solution can be coated to give a highly even film thickness. Since a premeasurement step is employed in this die coating method, the film thickness can be relatively easily controlled and little solvent evaporates in the coated part, which makes the method favorable.

In the case of an antireflective film comprising multiple layers, it is also possible to apply two or more layers simultaneously. For the simultaneous application, use may be made of methods reported in U.S. Pat. No. 2,761,791, U.S. Pat. No. 2,941,898, U.S. Pat. No. 3,508,947, U.S. Pat. No. 3,526,528 and KOTINGU KOGKAKU, Yuji Harasaki, p. 253, Asakura Shoten (1973).

### <Use of Antireflective Film>

### [Polarizing Plate]

In usual, a polarizing plate comprises a polarizing film and two protective films provided in both side thereof. It is preferable that the antireflective film according to the invention is employed as at least one of these protective films between which the polarizing film is inserted. By using the antireflective film also as the protective film, the production cost of the polarizing plate can be reduced. By using the antireflective film as the outermost layer, the reflection of outside light can be prevented and a polarizing plate having excellent scratch resistance, stain proofness and so on can be obtained.

### [Polarizing Film]

As the polarizing film, use may be made of a publicly known polarizing film or a polarizing film cut out from a continuous polarizing film sheet the absorption axis of which is neither parallel nor perpendicular to the lengthwise direction.

Such a continuous polarizing film sheet the absorption axis of which is neither parallel nor perpendicular to the lengthwise direction can be produced by the following method. That is, it can be produced by a stretching method which comprises stretching a polymer film by applying a tension while holding both ends of the film by holding members, stretching the thus obtained polarizing film at a stretching ratio of at least 1.1 to 20.0 in the film width direction, and flexing the film-traveling direction while holding its both ends so that the difference in the speed in the lengthwise direction between the holding members at the both ends of the film is not more than 3% and the angle between the film-traveling direction at the outlet of the step holding the both ends of the film and the actual stretching direction of the film is inclined at 20 to 70°. From the viewpoint of productivity, a film with an incline angle of 45° is preferably employed.

Methods of stretching polymer films are described in detail in the paragraphs [0020] to [0030] in JP-A-2002-86554.

### [Image Display Device]

The antireflective film of the invention and the polarizing plate having the antireflective film as one of the surface protective films of a polarizing film are preferably usable in liquid crystal display devices of transmission, reflection and semi-transmission modes such as twisted nematic (TN), super-twisted nematic (STN), vertical alignment (VA), in-place switching (IPS) and optically compensated bend cell (OCB) modes,

Liquid crystal cells of the VA mode include:

(1) a liquid crystal cell of VA mode in a narrow sense, in which rod-like liquid crystal molecules are substantially vertically aligned while voltage is not applied, and the molecules are substantially horizontally aligned while voltage is applied (JP-A-2-176625);

(2) a liquid crystal cell of MVA mode, in which the VA mode is modified to be multi-domain type so as to enlarge the viewing angle (described in SID97, Digest of tech. Papers, 28 (1997), p. 845);

(3) a liquid crystal cell of n-ASM mode, in which rod-like liquid crystal molecules are substantially vertically aligned while voltage is not applied, and the molecules are substantially oriented in twisted multi-domain alignment while voltage is applied (described in Nippon Ekisho Toronkai [Liquid crystal forum of Japan], Digest of tech. Papers (1998), 58-59); and

(4) a liquid crystal cell of SURVAIVAL mode (published in LCD international 98).

In a liquid crystal cell of the VA mode, it is preferable to employ a polarizing plate constructed by combining a biaxially stretched triacetylcellulose film with the antireflective film according to the invention. To produce such a biaxially stretched triacetylcellulose film, use may be preferably made of methods reported in, for example, JP-A-2001-249223 and JP-A-2003-170492.

A liquid crystal cell of the OCB mode is a liquid crystal display device with the use of a liquid crystal cell of bed alignment mode, in which rod-like liquid crystal molecules are aligned substantially in opposite directions (symmetrically) in the upper part and the lower part, as disclosed in U.S. Pat. No. 4,583,825 and U.S. Pat. No. 5,410,422. Since the rod-like liquid crystal molecules are symmetrically aligned in the upper part and the lower part, this liquid cell of the bend alignment mode has a self-optically compensatory function. Therefore, this liquid crystal mode is also called OCB (optically compensatory bend) liquid crystal mode. Such a liquid crystal display device of the bend alignment mode has an advantage of having a high response speed.

A liquid crystal cell of the ECB mode, in which rod-like liquid crystal molecules are substantially horizontally aligned while voltage is not applied, has been most frequently used as a color TFT liquid crystal display device and reported in a large number of documents, for example, EL, PDP, LCD Display, Toray Research Center (2001).

As described in, for example, JP-A-2001-10004, it is particularly preferable that in liquid crystal display devices of the TN mode and the IPS mode, an optically compensatory film is used in the opposite side of the antireflective film according to the invention, which is employed as one of the protective films in the front and back faces of a polarizing film, to thereby give a polarizing plate having an antireflective effect and a viewing angle-enlarging effect at the thickness of a single polarizing plate alone.

### EXAMPLES

Now, the invention will be illustrated in greater detail by reference to the following EXAMPLES. However, it is to be understood that the invention is not construed as being restricted thereto. Unless otherwise noted, all “%” are by mass.

### <Curable Composition>

### [Synthesis of Fluorine-Containing Crosslinking Agent]

### Example 1-1

### Synthesis of Fluorine-Containing Crosslinking Agent (H-3)

A mixture of 1.76 g of 2,4,6-tris[bis(methoxymethyl)amino]-1,3,5-triazine, 15.0 g of 2,2,2-trifluoroethanol and 140 mg of p-toluenesulfonic acid monohydride was heated under reflux with stirring for 4 hours and then cooled to room temperature. Then, 75 mg of triethylamine was added thereto. After adding 80 cm³ of ethyl acetate and 100 cm³ of water, the mixture was separated and the organic phase was further washed with water twice and dried over magnesium sulfate. The organic phase thus obtained was filtered and the solvent was distilled off under reduced pressure. Thus, 2.4 g of a crosslinking agent (H-3) was obtained as a colorless oily product.

¹H-NMR (CDCl₃): δ=3.34 (s, 9.0H), 3.89 to 4.09 (br, 6.0H), 5.01 to 5.20 (br, 6.0H), 5.20 to 5.39 (br, 6.0H). Since a singlet at 3.34 ppm and a broad signal at 3.89 to 4.09 ppm were assignable respectively to a methyl group originating in the starting material and a methylene group originating in the fluoroalkyl group, it was confirmed that the obtained crosslinking agent was a compound into which the methyl group and the trifluoroethyl group had been introduced at a ratio of 50/50 (by mol), i.e., the compound (H-3) in the above Table 1 represented by the above formula (2).

### Examples 1-2 to 1-4

Fluorine-containing crosslinking agents (H-6), (H-13) and (1′-14) were synthesized almost in the same manner as in the above EXAMPLE 1-1. The crosslinking agents thus obtained are as listed in the above formula (2) and Table 1.

### Example 1-5

### Synthesis of Fluorine-Containing Crosslinking Agent (H-28)

A mixture of 3.18 g of 1,3,4,6-tetrakis(methoxymethyl) glycol lauryl, 40 g of 2,2,2-trifluoroethanol and 0.32 g of p-toluenesulfonic acid monohydride was heated under reflux with stirring for 6 hours. Then, 0.2 cm³ of triethylamine was added thereto. After adding 120 cm³ of ethyl acetate and 120 cm³ of water, the mixture was separated and the organic phase was further washed with water twice and dried over magnesium sulfate. The organic phase thus obtained was filtered and the solvent was distilled off under reduced pressure. Thus, 3.7 g of a crosslinking agent (H-28) was obtained as a colorless oily product.

¹H-NMR (CDCl₃): δ=3.33 (s, 5.6H), 3.89 to 3.99 (m, 4.8H), 4.75 to 4.81 (m, 2H), 4.99 to 4.87 (m, 4H), 5.09 (d (J=11 Hz), 2H), 5.46 to 5.54 (m, 2H). Since a singlet at 3.33 ppm and a multilet at 3.89 to 3.99 ppm were assignable respectively to a methyl group originating in the starting material and a methylene group originating in the fluoroalkyl group, it was confirmed that the obtained crosslinking agent was a compound into which the methyl group and the trifluoroethyl group had been introduced at a ratio of 44/56 (by mol), i.e., the compound (H-28) in the above Table 2 represented by the above formula (3-2).

### Example 1-6

A fluorine-containing crosslinking agent (H-24) was synthesized almost in the same manner as in the above EXAMPLE 1-5. The crosslinking agent thus obtained is as listed in the above formula (3-2) and Table 2.

### [Synthesis of Fluoropolymer]

### Synthesis Example 1-1

### Synthesis of Fluoropolymer (P2)

Into a stainless autoclave having a capacity of 100 mL and being provided with a stirrer, 18.5 g of ethyl acetate, 8.8 g of hydroxyethyl vinyl ether (HEVE), 1.0 g of “SILAPLANE FM-0725” (manufactured by Chisso Corporation) and 0.40 g of “V-65” (a heat radical generator manufactured by Wako Pure Chemical Industries) were introduced. After degassing, the system was purged with nitrogen gas. Further, 15 g of hexafluoropropylene (HFP) was fed into the autoclave followed by heating to 62° C. When the temperature in the autoclave attained 62° C., the pressure therein was 8.9 kg/cm². While maintaining the temperature in the autoclave at 62° C., the reaction was continued for 9 hours. When the pressure attained 6.2 kg/cm², heating was ceased and the mixture was cooled by allowing to stand.

When the inner temperature fell to room temperature, the unreacted monomers were removed and the autoclave was opened to thereby take out the liquid reaction mixture. The liquid reaction mixture thus obtained was poured into a mixture of hexane with 2-propanol in large excess. After removing the solvent by decantation, the polymer thus precipitated was collected. Further, this polymer was dissolved in a small amount of ethyl acetate and precipitated twice from a mixture of hexane with 2-propanol to thereby completely remove the remaining monomers. After drying under reduced pressure, 8.3 g of P2 was obtained. The number-average molecular weight of the obtained polymer was 1.7×10⁴.

### Synthesis Example 1-2

### Synthesis of Fluoropolymer (P3)

Into a stainless autoclave having a capacity of 100 mL and being provided with a stirrer, 30 g of ethyl acetate, 8.8 g of hydroxyethyl vinyl ether (HEVE), 0.88 g of “VPS-1001” (a macroazo initiator, manufactured by Wake Pure Chemical Industries) and 0.29 g of lauroyl peroxide were introduced. After degassing, the system was purged with nitrogen gas. Further, 15 g of hexafluoropropylene (HFP) was fed into the autoclave followed by heating to 70° C. When the temperature in the autoclave attained 70° C., the pressure therein was 9.0 kg/cm². While maintaining the temperature in the autoclave at 70° C., the reaction was continued for 9 hours. When the pressure attained 6.0 kg/cm², heating was ceased and the mixture was cooled by allowing to stand.

When the inner temperature fell to room temperature, the unreacted monomers were removed and the autoclave was opened to thereby take out the liquid reaction mixture. The liquid reaction mixture thus obtained was poured into a mixture of hexane with 2-propanol in large excess. After removing the solvent by decantation, the polymer thus precipitated was collected. Further, this polymer was dissolved in a small amount of ethyl acetate and precipitated twice from a mixture of hexane with 2-propanol to thereby completely remove the remaining monomers. After drying under reduced pressure, 19.3 g of P3 was obtained. The number-average molecular weight of the obtained polymer was 2.1×10⁴.

### Synthesis Examples 1-3 to 1-9

Fluoropolymers (P1), (P7), (P8), (P9), (P14) and (P19) were synthesized almost in the same manner as in SYNTHESIS EXAMPLE 1. The number-average molecular weights of the fluoropolymers thus obtained are shown in the above Tables 12 and 13.

### [Synthesis of Curing Catalyst]

### Synthesis Example 2-1

### Preparation of p-toluenesulfonic Acid Triethylamine Salt Solution

3.0 g of triethylamine was dissolved in 30 mL of 2-butanone. Under stirring, 5.7 g of p-toluenesulfonic acid monohydride was added in portions thereto and the mixture was stirred for additional 1 hour to thereby prepare the catalyst.

### Synthesis Examples 2-2 and 2-3

A solution of p-toluenesulfonic acid 4-methylmorpholine salt and a solution of p-toluenesulfonic acid diethylmethylamine salt were prepared almost in the same manner as in SYNTHESIS EXAMPLE 2-1.

In the invention, use can be made of such a solution as obtained in SYNTHESIS EXAMPLES 2-1 to 2-3 as the curing catalyst. Alternatively, it is possible to use a salt in the solid state which is obtained after distilling off the solvent from the solution under reduced pressure.

### [Production of Curable Composition]

### Examples 2-1 to 2-23 and Comparative Examples 2-1 to 2-4

### Preparation of Coating Solutions for Low Refractive Index Layer (LL-1 to LL-23) and (LLr-1) to (LLr-4)

Coating solutions (solid content: 6%) for low refractive index layer were prepared by mixing the components listed in Table 14. In Table 14, numerical values in parentheses mean the contents (part by mass) of the individual components.

TABLE 14

| | | Coating solution for low refractive index layer | | | | | | | | |
|---|---|---|---|---|---|---|---|---|---|---|
| | | | | | | | | Compound having | | Colloidal |
| | | Fluoropolymer | | Curing agent | | Curing catalyst | | polysiloxane structure | | silica |
| | No. | Type | Amount | Type | Amount | Type | Amount | Type | Amount | Amount |
| Ex. 2-1 | LL-1 | P1 | (64) | H-3 | (20) | PTS Et₃N | (1.0) | FM4425 | (2.1) | (20) |
| Ex. 2-2 | LL-2 | ″ | (80) | H-6 | (20) | ″ | (1.0) | CMS626 | (2.4) | — |
| Ex. 2-3 | LL-3 | ″ | (75) | H-28 | (25) | PTS NMM | (1.5) | 160AS | (1.9) | — |
| C. Ex. 2-1 | LLr-1 | ″ | (64) | TBMAT | (20) | PTS Et₃N | (1.0) | FM4425 | (2.1) | (20) |
| Ex. 2-4 | LL-4 | P2 | (80) | H-3 | (20) | PTS NMM | (1.0) | — | — | — |
| Ex. 2-5 | LL-5 | ″ | (56) | H-13 | (24) | PTS Et₃N | (1.5) | — | — | (20) |
| Ex. 2-6 | LL-6 | ″ | (63) | H-24 | (27) | ″ | (1.5) | — | — | (10) |
| Ex. 2-7 | LL-7 | ″ | (75) | H-65 | (25) | PTS Et₂NMe | (1.2) | — | — | — |
| Ex. 2-8 | LL-8 | P3 | (70) | H-3 | (30) | PTS Et₃N | (1.0) | — | — | — |
| Ex. 2-9 | LL-9 | ″ | (60) | H-14 | (20) | ″ | (1.5) | — | — | (20) |
| Ex. 2-10 | LL-10 | ″ | (80) | H-28 | (20) | PTS NMM | (1.0) | — | — | — |
| Ex. 2-11 | LL-11 | P7 | (72) | H-3 | (18) | PTS Et₃N | (1.0) | FM4421 | (2.5) | (10) |
| Ex. 2-12 | LL-12 | ″ | (64) | H-65 | (16) | ″ | (1.2) | CMS626 | (2.0) | (20) |
| Ex. 2-13 | LL13 | ″ | ″ | H-24 | (16) | PTS Et₂NMe | (1.5) | FM4425 | (2.2) | ″ |
| C. Ex. 2-2 | LLr-2 | ″ | (72) | CY303 | (18) | PTS Et₃N | (1.0) | FM4421 | (2.5) | (10) |
| Ex. 2-14 | LL-14 | P8 | (85) | H-3 | (15) | PTS Et₃N | (1.0) | — | — | — |
| Ex. 2-15 | LL-15 | ″ | (64) | ″ | (16) | ″ | (1.5) | — | — | (20) |
| Ex. 2-16 | LL-16 | ″ | (70) | H-14 | (30) | ″ | (1.0) | — | — | — |
| Ex. 2-17 | LL-17 | ″ | (72) | H-6 | (18) | ″ | ″ | — | — | (10) |
| Ex. 2-18 | LL-18 | P9 | (64) | H-3 | (16) | ″ | (1.2) | — | — | (20) |
| Ex. 2-19 | LL-19 | ″ | (80) | ″ | (20) | PTS NMM | (2.0) | — | — | — |
| Ex. 2-20 | LL-20 | ″ | (70) | ″ | (30) | ″ | ″ | — | — | — |
| Ex. 2-21 | LL-21 | ″ | (64) | H-6 | (16) | PTS Et₃N | (1.5) | — | — | (20) |
| Ex. 2-22 | LL-22 | ″ | (80) | H-14 | (20) | ″ | (1.0) | — | — | — |
| Ex. 2-23 | LL-23 | ″ | (64) | H-28 | (16) | PTS Et₂NMe | (1.5) | — | — | (20) |
| C. Ex. 2-3 | LLr-3 | ″ | (80) | CY303 | (20) | PTS NMM | (2.0) | — | — | — |
| C. Ex. 2-4 | LLr-4 | ″ | (64) | MX270 | (16) | PTS Et₂NMe | (1.5) | — | — | (20) |

The abbreviations in Table 14 have the following meanings.

TBMAT: 2,4,6-tris[bis(methoxymethyl)amino]-1,3,5-triazine, manufactured by TOKYO CHEMICAL INDUSTRY Co., Ltd.
CY303: “CYMEL 303”, methylated melamine, manufactured by Nippon Cytec Industries.
MX270: “NIKALAC MX-270”, tetramethoxymethyl glycoluril, manufactured by Sanwa Chemical Co., Ltd.
FM4425: “FM-4425”, a compound having a polysiloxane structure, manufactured by Chisso Corporation.
FM4421: “FM-4421”, a compound having a polysiloxane structure, manufactured by Chisso Corporation.
CMS626: “CMS-626”, a compound having a polysiloxane structure, manufactured by Gelest.
160AS: “X-22-160AS”, a compound having a polysiloxane structure, manufactured by SHIN-ETSU CHEMICAL Co.
Colloidal silica: “MEK-ST” manufactured by Nissan Chemical Industries, Ltd.

The abbreviations showing curing catalysts have the following meanings. As these catalysts, the solutions prepared in SYNTHESIS EXAMPLES 2-1 to 2-3 were employed.

PTS Et₃N: p-toluenesulfonic acid triethylamine salt.
PTS NMM: p-toluenesulfonic acid 4-methylmorpholine salt.
PTS Et₂NMe: p-toluenesulfonic acid diethylmethylamine salt.

### [Preparation of Coating Solution for Hard Coat Layer (HC-1)]

| | |
|---|---|
| “PET-30” | 50.0 g |
| “IRGACURE 184” | 2.0 g |
| “SX-350” (30%) | 1.5 g |
| crosslinked acryl-styrene particles (30%) | 13.9 g |
| “KBM-5103” | 10.0 g |
| toluene | 38.5 g |

A liquid mixture comprising the above components was filtered through a polypropylene filter having a pore size of 30 μm to thereby give a coating solution for hard coat layer (HC-1).

The compounds employed are as follows.

“PET-30”: mixture of pentaerythritol triacrylate with pentaerythritol tetraacrylate (manufactured by NIPPON KAYAKU Co., Ltd.).
“IRGACURE 184”: polymerization initiator (manufactured by Ciba Specialty Chemicals).
“SX-350”: polystyrene particles having an average particle size of 3.5 μm (refractive index 1.60, manufactured by SOKEN KAGAKU K.K.), being in the form of a 30% dispersion in toluene having been dispersed in a Polytron dispersing machine at 10000 rpm for 20 minutes before using.
Crosslinked acryl-styrene particles: having an average particle size of 3.5 μm (refractive index 1.55, manufactured by SOKEN KAGAKU K.K.), being in the form of a 30% dispersion in toluene having been dispersed in a Polytron dispersing machine at 10000 rpm for 20 minutes before using.
“KBM-5103”: acryloyloxypropyltrimethoxysilane (manufactured by SHIN-ETSU CHEMICAL Co.).

### <Production of Antireflective Film>

### Example 3-1

### Production of Antireflective Film (101)

A triacetylcellulose film of 80 μm in thickness “FUJITAC TAC-TD80U” (manufactured by FUJI PHOTOFILM Co., Ltd. (now, FUJIFILM Corporation)) was unwound in a rolled state. Then the coating solution for hard coat layer (HC-1) as described above was coated by using a microgravure roll (diameter: 50 mm) having a gravure pattern of a line density of 180 lines/in. and a depth of 40 μm and a doctor blade at a gravure roll rotation speed of 30 rpm and a traveling speed of 30 m/min. After drying at 60° C. for 150 seconds, the coating layer was hardened by irradiating under nitrogen-purge to give an oxygen concentration of 0.1% by volume with ultraviolet light at 110 mJ/cm² by using an air-cool metal halide lamp (160 W/cm, manufactured by EYEGRAPHICS Co., Ltd.) at an illuminance of 400 mW/cm². Thus a hard coat layer of 6 μm in thickness was formed followed by winding. The surface roughness of the hard coat layer thus formed was Ra=0.18 μm and Rx=1.40 μm and the haze thereof was 35%.

On the hard coat layer thus obtained, the coating solution for low refractive index layer (LL-1) as described above was coated in such a manner as to give a low refractive index layer thickness of 95 nm to thereby give an antireflective film sample (101). The low refractive index layer was dried at 120° C. for 10 minutes. Curing was conducted under nitrogen-purge to give an oxygen concentration of 0.1% by volume or lower with ultraviolet light at 110 mJ/cm² by using an air-cool metal halide lamp (240 W/cm, manufactured by EYEGRAPHICS Co., Ltd.) at an illuminance of 120 mW/cm².

### Examples 3-2 to 3-23 and Comparative Examples 3-1 to 3-4

### Production of Antireflective Films (102) to (123) and (R01) to (R04)

Antireflective films (102) to (123) were produced as in producing the antireflective film (101) but respectively using (LL-2) to (LL-23) each as a substitute for the coating solution for low refractive index layer (LL-1). Similarly, comparative antireflective films (R01) to (R04) were produced as in producing the antireflective film (101) but respectively using (LLr-1) to (LLr-4) each as a substitute for the coating solution for low refractive index layer (LL-1).

### [Saponification of Antireflective Film]

Each of the obtained antireflective films was treated under the following standard saponification conditions and dried.

Alkali bath: 1.5 mol/dm³ aqueous sodium hydroxide solution, 55° C., 120 sec
First water bath: tap water 60 sec.
Neutralization bath: 0.05 mol/dm³ sulfuric acid, 30° C., 20 sec.
Second water bath: tap water, 60 sec.

### Drying: 120° C., 60 sec.

### [Evaluation of Antireflective Film]

The saponified antireflective films thus obtained were evaluated as follows. Table 15 shows the evaluation data and the layer constitutions of the individual antireflective films.

### (Evaluation 1) Measurement of Average Reflectivity

By using a spectrophotometer “V-550” (manufactured by JASCO), the spectral refractive index at an incident angle of 5′ in a wavelength range of from 380 to 780 nm was measured with the use of an integrating sphere. In evaluating the spectral reflectivity, the average reflectivity at 450 to 650 nm was employed.

After roughening the back face of the antireflective film, a light absorption treatment with a black ink (transmittance at 380 to 780 nm being less than 10%) was conducted and then the reflectivity was measured on a black table.

In the case of a sample having been processed into a polarizing plate as will be described hereinafter, the polarizing plate was employed as such in the measurement. In the case of a display device using no polarizing plate, the back face of the antireflective film was subjected successively to a surface-roughening treatment and a light absorption treatment with a black ink (transmittance at 380 to 780 nm being less than 10%) was conducted and then the reflectivity was measured on a black table.

(Evaluation 2) Evaluation of Scratch Resistance by Rubbing with Eraser

By using a rubbing tester, a rubbing test was conducted under the following conditions.

Environmental conditions for evaluation: 25° C., 60% RH.
Rubbing instrument: a plastic eraser (MONO® manufactured by TOMBOW) was fixed to the rubbing edge (1 cm×1 cm) of a tester to be contacted with a sample.
Moving distance (one way): 4 cm.
Rubbing speed: 2 cm/sec.
Load: 500 g/cm².
Contact area at edge: 1 cm×1 cm.
Number of rubbing: 100 reciprocating motions.

After the completion of the rubbing, a black ink was applied to the back face of the sample and then the sample was observed with the naked eye under reflection. Thus, marks in the rubbed part were evaluated in accordance with the following criteria.

A: No mark was found even in careful observation.

B: Slight and subtle marks were found in careful observation.

C: Subtle marks were found.

D: Moderate marks were found.

E: Obvious marks were found.

F: Marks were found all over the surface.

TABLE 15

| | | Antireflective film | | | |
|---|---|---|---|---|---|
| | | Constitution | | | |
| | | Coating | Coating | | |
| | | solution | solution for | Characteristics | |
| | | for | low refractive | Average | Eraser |
| | Sample | hard coat | index layer | reflectivity | scratch |
| | no. | layer no. | no. | (%) | resistance |
| Ex. 3-1 | 101 | HC-1 | LL-1 | 1.82 | A |
| Ex. 3-2 | 102 | ″ | LL-2 | 1.81 | A |
| Ex. 3-3 | 103 | ″ | LL-3 | 1.79 | B |
| C. Ex. 3-1 | R01 | ″ | LLr-1 | 1.86 | A |
| Ex. 3-4 | 104 | ″ | LL-4 | 1.82 | A |
| Ex. 3-5 | 105 | ″ | LL-5 | 1.83 | A |
| Ex. 3-6 | 106 | ″ | LL-6 | 1.80 | B |
| Ex. 3-7 | 107 | ″ | LL-7 | 1.82 | B |
| Ex. 3-8 | 108 | ″ | LL-8 | 1.82 | A |
| Ex. 3-9 | 109 | ″ | LL-9 | 1.81 | A |
| Ex. 3-10 | 110 | ″ | LL-10 | 1.78 | B |
| Ex. 3-11 | 111 | ″ | LL-11 | 1.82 | A |
| Ex. 3-12 | 112 | ″ | LL-12 | 1.81 | B |
| Ex. 3-13 | 113 | ″ | LL-13 | 1.78 | B |
| C. Ex. 3-2 | R02 | ″ | LLr-2 | 1.87 | A |
| Ex. 3-14 | 114 | ″ | LL-14 | 1.81 | A |
| Ex. 3-15 | 115 | ″ | LL-15 | 1.82 | A |
| Ex. 3-16 | 116 | ″ | LL-16 | 1.80 | A |
| Ex. 3-17 | 117 | ″ | LL-17 | 1.82 | A |
| Ex. 3-18 | 118 | ″ | LL-18 | 1.82 | A |
| Ex. 3-19 | 119 | ″ | LL-19 | 1.81 | A |
| Ex. 3-20 | 120 | ″ | LL-20 | 1.83 | A |
| Ex. 3-21 | 121 | ″ | LL-21 | 1.81 | A |
| Ex. 3-22 | 122 | ″ | LL-22 | 1.81 | A |
| Ex. 3-23 | 123 | ″ | LL-23 | 1.79 | B |
| C. Ex. 3-3 | R03 | ″ | LLr-3 | 1.86 | A |
| C. Ex. 3-4 | R04 | ″ | LLr-4 | 1.82 | B |

This EXAMPLE clearly shows that the antireflective film samples (101) to (123) of EXAMPLES 3-1 to 3-23 according to the invention have regulated reflectivities and excellent scratch resistances.

As these results shows, it is obvious that a coating solution having both of a high stability and a high curing activity can be obtained by satisfying the requirements of the invention and, in its turn, an antireflective film with excellent qualities can be produced.

### Example 4-1

A multilayer antireflective film of the following composition was produced.

### [Preparation of Coating Solution for Hard Coat Layer (HC-2)]

100 parts by mass of “DESOLITE Z7404” (a zirconia particle-containing hard coat composition; manufactured by JSR), 31 parts by mass of “DPHA” (an UV-curing resin; manufactured by NIPPON KAYAKU Co., Ltd.), 10 parts by mass of “KBM-5103” (a silane coupling agent; manufactured by SHIN-ETSU CHEMICAL Co., Ltd.), 29 parts by mass of methyl ethyl ketone (MEK), 13 parts by mass of methyl isobutyl ketone (MIBK) and 5 parts by mass of cyclohexnone were fed into a mixing tank and stirred to thereby give a coating solution for hard coat layer (HC-2).

### [Production of Antireflective Film (201)]

As a support, a triacetylcellulose film “FUIJITAC TAC-TD80U” (manufactured by FUJI PHOTOFILM Co., Ltd. (now, FUJIFILM Corporation)) was unwound in a rolled state. Then the coating solution for hard coat layer (HCL-2) as described above was coated by using a microgravure roll (diameter: 50 mm) having a gravure pattern of a line density of 135 lines/in. and a depth of 60 μm and a doctor blade at a gravure roll rotation speed of 30 rpm and a traveling speed of 10 m/min. After drying at 60° C. for 150 seconds, the coating layer was hardened by irradiating under nitrogen-purge with ultraviolet light at 100 mJ/cm² by using an air-cool metal halide lamp (160 W/cm, manufactured by EYEGRAPHICS Co., Ltd.) at an illuminance of 400 mW/cm². Thus a hard coat layer was formed followed by winding. The hard coat layer was formed while controlling the rotational speed of the gravure roll so as to give a thickness of the cured hard coat layer of 4.0 μm.

On the hard coat layer thus obtained, the coating solution for low refractive index layer (LL-1) as described above was coated in such a manner as to give a low refractive index layer thickness of 95 nm to thereby give an antireflective film sample (201). The low refractive index layer was dried at 110° C. for 10 minutes. Curing was conducted under nitrogen-purge to give an oxygen concentration of 0.01% by volume or lower with ultraviolet light at 240 mJ/cm² by using an air-cool metal halide lamp (240 W/cm, manufactured by EYEGRAPHICS Co., Ltd.) at an illuminance of 120 mW/cm².

### Examples 4-2 to 4-23

### Production of Antireflective Films (202) to (223)

Antireflective films (202) to (223) were produced as in producing the antireflective film (201) but respectively using (LL-2) to (LL-23) each as a substitute for the coating solution for low refractive index layer (LL-1). Table 16 shows the layer constitutions of the individual antireflective films thus obtained.

TABLE 16

| | Antireflective film | | |
|---|---|---|---|
| | | Constitution | |
| | Sample | Coating solution for hard | Coating solution for low |
| | no. | coat layer no. | refractive index layer no. |
| Ex. 4-1 | 201 | HC-2 | LL-1 |
| Ex. 4-2 | 202 | ″ | LL-2 |
| Ex. 4-3 | 203 | ″ | LL-3 |
| Ex. 4-4 | 204 | ″ | LL-4 |
| Ex. 4-5 | 205 | ″ | LL-5 |
| Ex. 4-6 | 206 | ″ | LL-6 |
| Ex. 4-7 | 207 | ″ | LL-7 |
| Ex. 4-8 | 208 | ″ | LL-8 |
| Ex. 4-9 | 209 | ″ | LL-9 |
| Ex. 4-10 | 210 | ″ | LL-10 |
| Ex. 4-11 | 211 | ″ | LL-11 |
| Ex. 4-12 | 212 | ″ | LL-12 |
| Ex. 4-13 | 213 | ″ | LL-13 |
| Ex. 4-14 | 214 | ″ | LL-14 |
| Ex. 4-15 | 215 | ″ | LL-15 |
| Ex. 4-16 | 216 | ″ | LL-16 |
| Ex. 4-17 | 217 | ″ | LL-17 |
| Ex. 4-18 | 218 | ″ | LL-18 |
| Ex. 4-19 | 219 | ″ | LL-19 |
| Ex. 4-20 | 220 | ″ | LL-20 |
| Ex. 4-21 | 221 | ″ | LL-21 |
| Ex. 4-22 | 222 | ″ | LL-22 |
| Ex. 4-23 | 223 | ″ | LL-23 |

The antireflective films (201) to (223) were evaluated as in EXAMPLE 1. As a result, similar effects could be established by using the low refractive index layers according to the invention.

### <Utilization of Antireflective Film>

[Production of Polarizing Plate Provided with Antireflective Film]

### Example 5

Iodine was adsorbed by a stretched polyvinyl alcohol film to give a polarizing film. Next, the saponified antireflective film produced in EXAMPLE 3 was bonded to one side of the polarizing film by using a polyvinyl alcohol-based adhesive in such a manner that the support (triacetyl cellulose) side of the antireflective film was located in the polarizing film side. A viewing angle-enlarging film having an optically compensatory layer (WIDE VIEW FILM SA-12B, manufactured by FUJI PHOTOFILM CO., LTD. (now, FUJIFILM Corporation)) was saponified and bonded to the other side of the polarizing film by using a polyvinyl alcohol-based adhesive. Thus, a polarizing plate was constructed. This polarizing plate was subjected to the same evaluation as in EXAMPLE 1. As a result, similar effects could be established by using the low refractive index layers according to the invention.

### [Production of Image Display Device]

### Example 6

The polarizing plate samples of EXAMPLE 5 using the antireflective film samples of EXAMPLES 3 and 4 and the antireflective film of EXAMPLE 3 were each bonded to the surface glass plate of an organic EL display device via a pressure-sensitive adhesive. As a result, the reflection on the glass surface was regulated and a display device showing a high visibility was obtained in each case. Compared with the antireflective film using the comparative film, the antireflective films produced by using the curable compositions of the inventions showed superior effects.

### INDUSTRIAL APPLICABILITY

The curable composition of the invention can provide a cured product that has a high curing activity and a low refractive index. Thus, it enables the formation of a cured film being excellent in scratch resistance and having a low refractive index. An antireflective film formed by using a low refractive index layer that is formed by using the above-described composition is excellent in scratch resistance and has a low refractive index. Moreover, an image display device provided with the antireflective film of the invention and an image display device provided with a polarizing plate with the use of the antireflective film of the invention show little extraneous images and background images and have extremely high visibility.

The entire disclosure of each and every foreign patent application from which the benefit of foreign priority has been claimed in the present application is incorporated herein by reference, as if fully set forth.

1-11. (canceled)

12. A curable composition, which comprises:
at least one hydroxyl group-containing polymer;
at least one crosslinking agent having a fluorine atom and being reactive with hydroxyl group; and
at least one curing catalyst.

13. The curable composition of claim 12,
wherein the at least one crosslinking agent has an aminoplast skeleton.

14. The curable composition of claim 12,
wherein the at least one hydroxyl group-containing polymer is a polymer containing at least one fluorine-containing vinyl monomer polymerization unit (a) and at least one hydroxyl group-containing vinyl monomer polymerization unit (b).

15. The curable composition of claim 14,
wherein the at least one crosslinking agent has an aminoplast skeleton.

16. The curable composition of claim 12,
wherein the at least one hydroxyl group-containing polymer contains a polysiloxane repeating unit represented by formula (1) in a main chain or a side chain thereof: 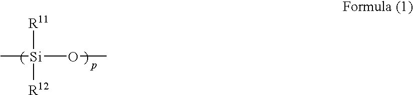
wherein R¹¹ and R¹² may be the same or different and each independently represents a substituted or unsubstituted alkyl or aryl group; and
p is an integer of from 1 to 500.

17. The curable composition of claim 16,
wherein the at least one crosslinking agent has an aminoplast skeleton.

18. The curable composition of claim 13,
wherein the at least one hydroxyl group-containing polymer contains a polysiloxane repeating unit represented by formula (1) in a main chain or a side chain thereof: 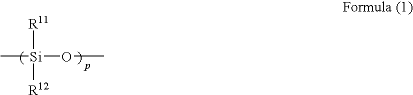
wherein R¹¹ and R¹² may be the same or different and each independently represents a substituted or unsubstituted alkyl or aryl group; and
p is an integer of from 1 to 500.

19. The curable composition of claim 18,
wherein the at least one crosslinking agent has an aminoplast skeleton.

20. The curable composition of claim 12,
wherein the at least one crosslinking agent is a compound represented by formula (2) or (3) or a partial condensation product thereof: 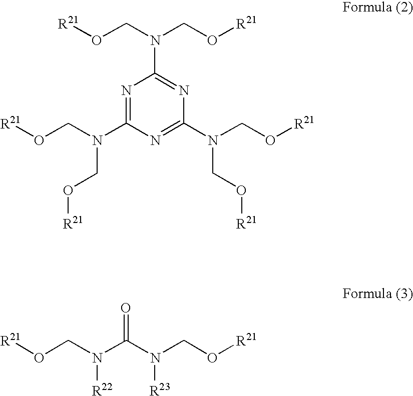
wherein R²¹'s each independently represents a hydrogen atom or an alkyl group optionally having a substituent, provided that at least one of R²¹'s is an alkyl group substituted by three or more fluorine atoms; and
R²² and R²³ each independently represents a hydrogen atom or an alkyl group optionally having a substituent, provided that R²² and R²³ may be bonded together to form a ring and R²² and R²³ may further form together a fused ring.

21. The curable composition of claim 20,
wherein the at least one crosslinking agent is a compound represented by formula (2) or a partial condensation product thereof: 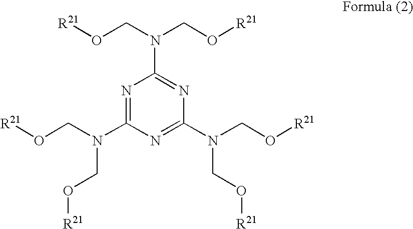
wherein R²¹'s each independently represents a hydrogen atom or an alkyl group optionally having a substituent, provided that at least one of R²¹'s is an alkyl group substituted by three or more fluorine atoms.

22. The curable composition of claim 20,
wherein the at least one crosslinking agent is a compound represented by formula (3) or a partial condensation product thereof: 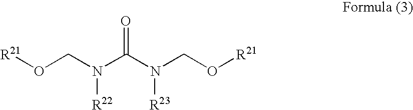
wherein R²¹'s each independently represents a hydrogen atom or an alkyl group optionally having a substituent, provided that at least one of R²¹'s is an alkyl group substituted by three or more fluorine atoms; and
R²² and R²³ each independently represents a hydrogen atom or an alkyl group optionally having a substituent, provided that R²² and R²³ may be bonded together to form a ring and R²² and R²³ may further form together a fused ring.

23. The curable composition of claim 14,
wherein the at least one crosslinking agent is a compound represented by formula (2) or (3) or a partial condensation product thereof: 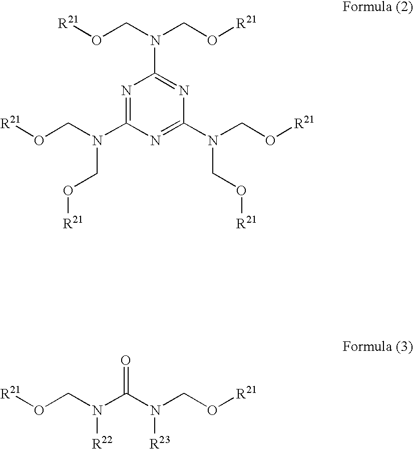
wherein R²¹'s each independently represents a hydrogen atom or an alkyl group optionally having a substituent, provided that at least one of R²¹'s is an alkyl group substituted by three or more fluorine atoms; and
R²² and R²³ each independently represents a hydrogen atom or an alkyl group optionally having a substituent, provided that R²² and R²³ may be bonded together to form a ring and R²² and R²³ may further form together a fused ring.

24. The curable composition of claim 16,
wherein the at least one crosslinking agent is a compound represented by formula (2) or (3) or a partial condensation product thereof: 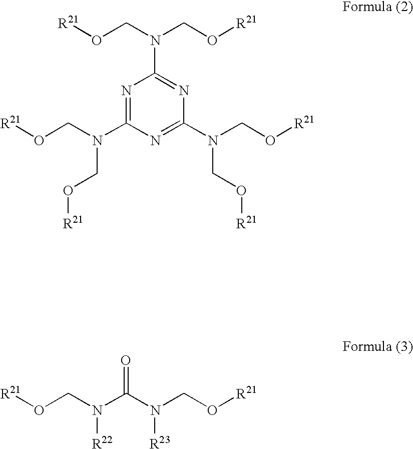
wherein R²¹'s each independently represents a hydrogen atom or an alkyl group optionally having a substituent, provided that at least one of R²¹'s is an alkyl group substituted by three or more fluorine atoms; and
R²² and R²³ each independently represents a hydrogen atom or an alkyl group optionally having a substituent, provided that R²² and R²³ may be bonded together to form a ring and R²² and R²³ may further form together a fused ring.

25. A cured product obtained by heating a curable composition of claim 12.

26. A laminate film, which comprises:
a transparent support; and
a layer that is formed by coating a curable composition of claim 12.

27. An antireflective film, which comprises:
a transparent support; and
a low refractive index layer that is formed by coating a curable composition of claim 14.

28. A polarizing plate, which comprises:
a polarizing film; and
at least two protective films for the polarizing film,
wherein at least one of the at least two protective films is an antireflective film of claim 27.

29. An image display device, which comprises an antireflective film of claim 27 as the outermost face of the display.

30. An image display device, which comprises a polarizing plate of claim 28 as the outermost face of the display.
